(19) United States
(12) Patent Application Publication
(10) Pub. No.: US 2011/0047114 A1
(43) Pub. Date: Feb. 24, 2011

(54) METHOD, APPARATUS AND COMPUTER PROGRAM FOR ENABLING MANAGEMENT OF RISK AND/OR OPPORTUNITY

(75) Inventors: Simon Marvell, Farnham (GB); Richard Mayall, London (GB)

Correspondence Address: CONLEY ROSE, P.C.;David A. Rose, P. O. BOX 3267, HOUSTON, TX, 77253-3267, US

(73) Assignee: ACUITY RISK MANAGEMENT LLP, London (GB)

(21) Appl. No.: 12/681,337

(22) PCT Filed: Oct. 2, 2008
(86) PCT No.: PCT/EP08/63250

§ 371 Date: Aug. 13, 2010

Related U.S. Application Data
(60) Provisional application No. 60/977,314, filed on Oct. 3, 2007.

(51) Int. Cl. G06N 5/02; G06F 3/048

(52) U.S. Cl. 706/46; 715/771

(57) ABSTRACT

The invention relates to a method for enabling management of at least one opportunity having a maximum opportunity level and to which one or more exploits that realise the opportunity can be applied, the method comprising: (i) determining the total opportunity improvement of all exploits applicable to at least one opportunity assuming that all said exploits are fully applied to realise the opportunity and that all said exploits are independent of each other; (ii) determining the contribution of the or each said exploit to said total opportunity increase; (iii) determining the level of actual opportunity increase from each said exploit taking into account, for each of said exploits, the contribution of the or each exploit to said total opportunity increase, the dependency of the exploit on other exploits applicable to said opportunity, and the degree to which the exploit is applied to realise said opportunity; and, (iv) determining from said levels of actual opportunity increase from each said exploit the total actual result improvement applied to said result.

The present invention relates to a method, apparatus and a computer program for enabling management of risk and/or opportunity.

There are many scenarios in which it is desirable to assess and manage “risk”. In general terms, risk can be regarded as some potential hazard or source of danger or harm to people, property, the environment, the economic welfare of a business or other organisation, etc.

An opportunity can be considered to be a negative risk or, more intuitively, a risk can be considered to be a negative opportunity.

In some scenarios, it is practically essential to manage risk, for example for reasons of safety or good practice generally, or because of legislative requirements. In general terms, risk management relates to determining whether a hazard exists and whether some mitigating action is required to reduce the level of risk presented by the hazard (for example to a level that is deemed acceptable by some criterion or criteria).

In addition, it is often necessary to manage opportunity either alone or as well as risk so that strategic decisions can be taken on a rational basis regarding the opportunities available to a business or other such organisation. In general terms, opportunity management relates to determining whether a positive outcome exists and whether some action is required to bring about or realise the outcome. In combination, where risks and opportunities are to be managed, a desired objective is to provide a net opportunity and risk adjusted forecast. In other words, an initial forecast is adjusted to take into account both risks and opportunities that could affect the initial forecast.

Many businesses and other organisations apply some form of risk and/or opportunity management across many diverse areas of their activities. For example, risk management is used in one form or another to determine the risk to the business if there is a failure of computer equipment (from an individual desktop computer, through network equipment, to the main computer servers operated by the business); if there is a breach of confidentiality (e.g. by an employee “leaking” a document publicly or to a competitor, whether deliberately or not); if there is an accident at a manufacturing plant; if there is an attack on an asset (whether for example a so-called cyber-attack by third parties on computer systems or a physical attack on physical equipment, e.g. an attack on an oil refinery); etc.,

Such risk and/or opportunity management is often applied in a fairly ad hoc basis, often by “feel” by the individuals concerned in the organisation based on their own personal experiences, and prejudices, and without much real objectivity. Some attempts have been made to render risk management more objective and transparent. However, none of these prior art approaches successfully allows for easy presentation of the degree of risk that an organisation is subject to at a particular point in time in relation to its appetite for risk. Also, none of these prior art approaches allows for easy aggregation of risk from one part of an organisation with risk from another part of the organisation in a manner that properly takes account of relevant factors.

It will be understood that in the present context, “risk” and “opportunity” (and correspondingly other terms used herein, such as “control”, “exploit”, “impact”, etc.) are used broadly to cover many varied examples of such things and such terms are likewise to be construed broadly, unless the context requires otherwise.

U.S. Pat. No. 7,305,351 discloses a method of projecting a future condition of a business by identifying a plurality of risks and a plurality of opportunities and evaluating at predetermined times in respect of each of the risks and each of the opportunities a potential impact on the future condition of the business entity.

According to a first aspect of the present invention, there is provided a method for enabling management of at least one risk having an untreated risk level and to which one or more controls that mitigate the risk can be applied, the method comprising:

(i) determining the total risk reduction of all controls applicable to at least one risk assuming that all said controls are fully applied to mitigate said risk and that all said controls are independent of each other;

(ii) determining the contribution of the or each said control to said total risk reduction;

(iii) determining the level of actual risk reduction from each said control taking into account, for each of said controls, the contribution of the or each control to said total risk reduction, the dependency of the control on other controls applicable to said risk, and the degree to which the control is applied to mitigate said risk; and,

(iv) determining from said levels of actual risk reduction from each said control the total actual risk reduction applied to said risk.

This allows an individual or an organisation, etc. to determine in an effective and sophisticated manner the total actual risk reduction applied to a risk taking into account the necessary relevant factors. An important consideration here is that the method allows the dependency of the control on other controls applicable to the risk to be taken into account. In addition to providing a more accurate assessment of the actual risk reduction that is applied, this also allows an indication to be had of how effective various controls are relative to each other in reducing the risk.

In an embodiment, said risk can have plural different impacts, and (i) to (iv) are carried out for each impact for said risk. This allows for a more complete assessment of the actual risk reduction to be made in such circumstances.

In an embodiment, the method comprises determining the potential residual risk of said risk in terms of the level of said risk in the case that all said applicable controls that mitigate said risk are fully applied to said risk. In this embodiment, the potential residual risk is in effect the minimum remaining risk in the case that all applicable controls that can be applied to mitigate the risk are fully applied.

In an embodiment, the method comprises causing a display device to display a representation of said potential residual risk.

In an embodiment, the method comprises:

determining the total actual residual risk resulting from application of said controls to said risk; and,

causing a display device to display a representation of said total actual residual risk.

In an embodiment, the representation of said total actual residual risk is a representation of said total actual residual risk as a proportion of risk appetite as input by a user.

In each of these last three embodiments, the user can be presented with graphical representations that are quickly and easily interpreted. Moreover, in the preferred embodiments, the user can adjust the values of the various input variables and be immediately presented with new representations which show the effect of adjusting the values of the various input variables. As will be explained below similar embodiments are also provided in respect of the management of opportunity as well as or instead of risk.

In an embodiment, there are plural risks, and the method comprises:

carrying out the method in respect of each of the plural risks; and,

determining the total actual residual risk of all of the plural risks by summing the total actual risk reductions applied to each of said risks.

According to a second aspect of the present invention, there is provided apparatus for enabling management of at least one risk having an untreated risk level and to which one or more controls that mitigate the risk can be applied, the apparatus being arranged to:

(i) determine the total risk reduction of all controls applicable to at least one risk assuming that all said controls are fully applied to mitigate said risk and that all said controls are independent of each other;

(ii) determine the contribution of the or each said control to said total risk reduction;

(iii) determine the level of actual risk reduction from each said control taking into account, for each of said controls, the contribution of the or each control to said total risk reduction, the dependency of the control on other controls applicable to said risk, and the degree to which the control is applied to mitigate said risk; and,

(iv) determine from said levels of actual risk reduction from each said control the total actual risk reduction applied to said risk.

According to a third aspect of the present invention, there is provided a method of displaying the effect of applying one or more controls to a risk to mitigate the risk, the method comprising:

displaying on a display device a representation of the potential residual risk of a risk, the potential residual risk of the risk being a measure of the level of said risk in the case that all applicable controls that mitigate said risk are fully applied to said risk; and,

displaying on the display device a representation of the total actual risk reduction applied to said risk by application of said one or more controls as a proportion of a risk appetite input by a user.

This aspect provides the user with graphical representations of relevant information that are quickly and easily interpreted. The user can see, at a glance, whether for example they are currently operating above or below their risk appetite. In the preferred embodiment, the user can “drill down” to investigate the risks and controls in detail. Moreover, in the preferred embodiments, the user can adjust the values of the various input variables and be immediately presented with new representations which show the effect of adjusting the values of the various input variables.

In an embodiment, the potential residual risk of said risk and the total actual risk reduction applied to said risk as a proportion of a risk appetite input by a user are represented on the display device by respective pointers on the same gauge. This provides a representation of the data that is particularly easily interpreted by the user.

In an embodiment, the method comprises displaying on the display device a representation of the degree to which said one or more controls are applied to mitigate said risk. This allows the user easily to track the degree to which the controls are applied.

In an embodiment, the method comprises:

displaying on the display device information relating to said risk;

detecting selection on the display device of said information relating to said risk and, in response thereto, displaying information on the display device relating to said one or more controls that can be applied to mitigate said risk. This allows the user to “drill down” to investigate the risks and controls in detail.

In an embodiment, the information relating to said one or more controls that can be applied to mitigate said risk that is displayed on the display device includes information relating to the degree to which said one or more controls are applied to mitigate said risk.

According to a fourth aspect of the present invention, there is provided apparatus for displaying the effect of applying one or more controls to a risk to mitigate the risk, the apparatus comprising:

a display device;

the apparatus being arranged to:

display on the display device a representation of the potential residual risk of a risk, the potential residual risk of the risk being a measure of the level of said risk in the case that all applicable controls that mitigate said risk are fully applied to said risk; and,

display on the display device a representation of the total actual risk reduction applied to said risk by application of said one or more controls as a proportion of a risk appetite input by a user.

There may also be provided a computer program containing instructions for causing a computer to carry out a method as described above.

Where opportunity is to be managed together with risk, firstly, the positive effects of opportunity and the negative effects of risk can be measured against some form of planned or expected result, i.e. an “Initial Results Forecast.” For example, a business unit might have a plan to achieve sales of £10 m which could be affected positively by opportunities or negatively by risks. In addition, the effects of opportunities and risks on results are preferably considered across multiple time periods. Whereas with risk only, the method of management takes into account a current situation, for opportunity, by its nature the method looks forward in time to see how opportunities might affect the enterprise. For example, a business unit might have a plan to achieve sales of £10 m this year, £12 m next year and £15 m the year after. The Initial Results Forecast may also be used when opportunity is managed alone so that the positive effects of opportunity can be measured against some form of planned or expected result.

According to a further aspect of the present invention, there is provided a method for enabling management of the effects on an Initial Results Forecast of at least one risk having an untreated risk level and to which one or more controls that mitigate the risk can be applied in combination with at least one opportunity to which one or more exploits can be applied to realise the opportunity, the method comprising:

(i) determining the total risk reduction of all controls applicable to at least one risk assuming that all said controls are fully applied to mitigate said risk and that all said controls are independent of each other;

(ii) determining the contribution of the or each said control to said total risk reduction;

(iii) determining the level of actual risk reduction from each said control taking into account, for each of said controls, the contribution of the or each control to said total risk reduction, the dependency of the control on other controls applicable to said risk, and the degree to which the control is applied to mitigate said risk;

(iv) determining the total increase in opportunity of all exploits applicable to at least one opportunity assuming that all said exploits are fully applied to increase the opportunity and that all said exploits are independent of each other;

(v) determining the contribution of the or each said exploit to said total increase in opportunity;

(vi) determining the level of actual opportunity increase from each said exploit taking into account, for each of said exploits, the contribution of the or each exploit to said total increase in opportunity, the dependency of the exploit on other exploits applicable to said opportunity, and the degree to which the exploit is applied to realise said opportunity; and,

(vii) determining from said levels of actual risk reduction from each said control and said levels of actual opportunity increase the total actual risk reduction and opportunity increase applied to said risk and opportunity to determine an effect on the Initial Results Forecast.

This allows an individual or an organisation, etc. to determine in an effective and sophisticated manner the total actual opportunity realisation taking into account the necessary relevant factors. An important consideration here is that the method allows the dependency of the exploits on other exploits applicable to the opportunity to be taken into account. In addition to providing a more accurate assessment of the actual opportunity realisation that is applied, this also allows an indication to be had of how effective various exploits are relative to each other in realising the opportunity.

By taking into account both the “positive” effect of opportunity and the negative effect of “risk”, the results forecast can be adjusted to provide useful information to decision makers. Furthermore, by providing a system in which parameters, e.g. the exploits and deployment thereof, can be varied, the effect on the results forecast of individual opportunities can be seen and understood.

In a preferred embodiment, the effects on the Initial Results Forecast of the at least one risk in combination with the at least one opportunity is determined for a selected time period. The effects are preferably determined for plural different time periods, e.g. the next 12, 24, 36 months (or any other desired time period). Thus, the method provides a way in which the changing effect of one or more risks and opportunities on an organisation can be managed over different time periods.

According to one aspect of the present invention, there is provided a method for enabling management of at least one opportunity having a maximum opportunity level and to which one or more exploits that realise the opportunity can be applied, the method comprising:

(i) determining the total opportunity improvement of all exploits applicable to at least one opportunity assuming that all said exploits are fully applied to realise the opportunity and that all said exploits are independent of each other;

(ii) determining the contribution of the or each said exploit to said total opportunity increase;

(iii) determining the level of actual opportunity increase from each said exploit taking into account, for each of said exploits, the contribution of the or each exploit to said total opportunity increase, the dependency of the exploit on other exploits applicable to said opportunity, and the degree to which the exploit is applied to realise said opportunity; and,

(iv) determining from said levels of actual opportunity increase from each said exploit the total increase in opportunity or actual result improvement applied to said result.

The opportunity can have plural different types of result improvement, and steps (i) to (iv) are then carried out for each type of result improvement for said opportunity.

Preferably, the method comprises determining the potential opportunity of said opportunity in terms of the level of said opportunity in the case that all said applicable exploits that realise said opportunity are fully applied to said opportunity.

Preferably, the method comprises causing a display device to display a representation of said potential opportunity. Thus, a user friendly and intuitive means is provided by which representation of the potential opportunity can made to a user.

In one embodiment, the method comprises:

determining the total actual opportunity resulting from application of said exploits to said opportunity; and,

causing a display device to display a representation of said total actual opportunity.

According to a further aspect of the present invention, there is provided a method of displaying the effect on an Initial Results Forecast of applying one or more exploits to an, opportunity to realise the opportunity and one or more controls to a risk to reduce the risk, the method comprising:

displaying on a display device a representation of the potential results, the potential results being a measure of the results in the case that all applicable exploits that realise said opportunity are fully applied to said opportunity and all applicable controls that reduce said risk are fully applied to said risk.

As with risks management described above, this aspect provides the user with graphical representations of relevant information that are quickly and easily interpreted. The user can see, at a glance, whether for example they are currently operating above or below their results appetite. In a preferred embodiment, the user can “drill down” to investigate the opportunities and exploits in detail. Moreover, in the preferred embodiments, the user can adjust the values of the various input variables and be immediately presented with new representations which show the effect of adjusting the values of the various input variables.

Preferably, the method of this aspect also comprises displaying on the display device the net opportunity and risk adjusted forecast as a proportion of a results appetite input by a user, the net opportunity and risk adjusted forecast being determined by the actual risk reductions by application of said one or more controls and opportunity increases by application of said one or more exploits.

Preferably, the representation of the potential results and the net opportunity and risk adjusted forecast as a proportion of a results appetite input by a user are represented on the display device by respective pointers on the same gauge.

In one example, the method comprises displaying on the display device a representation of the degree to which said one or more exploits and/or controls are applied to realise said opportunity.

In one example, the method comprises:

displaying on the display device information relating to said opportunity;

detecting selection on the display device of said information relating to said opportunity and, in response thereto, displaying information on the display device relating to said one or more exploits that can be applied to realise said opportunity.

Thus, a method is provided by which a user can vary inputs to the system and be provided with appropriate information to provide an understanding and control of the opportunities.

Preferably, the information relating to said one or more exploits that can be applied to realise said opportunity that is displayed on the display device includes information relating to the degree to which said one or more exploits are applied to realise said opportunity. Thus, a user can see easily and readily appreciate if the degree to which the one or more exploits are applied needs to be modified or changed in any way.

According to a further aspect of the present invention, there is provided a method of displaying the effect of applying one or more exploits to an opportunity to realise the opportunity, the method comprising:

displaying on a display device a representation of the potential opportunity of an opportunity, the potential opportunity of the opportunity being a measure of the level of said opportunity in the case that all applicable exploits that realise said opportunity are fully applied to said opportunity; and,

displaying on the display device a representation of the total actual opportunity increase applied to said opportunity by application of said one or more exploits as a proportion of a results appetite input by a user.

This aspect provides the user with graphical representations of relevant information that are quickly and easily interpreted. The user can see, at a glance, whether for example they are currently operating above or below their results appetite. In a preferred embodiment, the user can “drill down” to investigate the opportunities and exploits in detail. Moreover, in the preferred embodiments, the user can adjust the values of the various input variables and be immediately presented with new representations which show the effect of adjusting the values of the various input variables.

According to a further aspect of the present invention, there is provided apparatus for displaying the effect of applying one or more exploits to an opportunity to realise the opportunity, the apparatus comprising:

a display device;

the apparatus being arranged to:

display on the display device a representation of the potential opportunity of an opportunity, the potential opportunity of the opportunity being a measure of the level of the opportunity in the case that all applicable exploits that realise said opportunity are fully applied to said opportunity; and,

display on the display device a representation of the total actual increase in results achieved by the opportunity by application of said one or more exploits as a proportion of a results appetite input by a user.

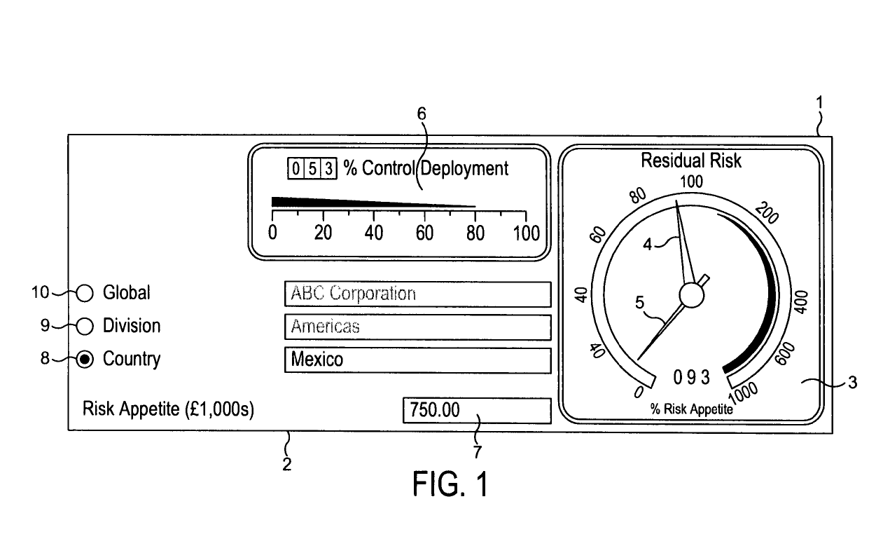

Embodiments of the present invention will now be described by way of examples with reference to the accompanying drawings, in which FIGS. 1 to 7 and 9 show examples of displays on a display device;

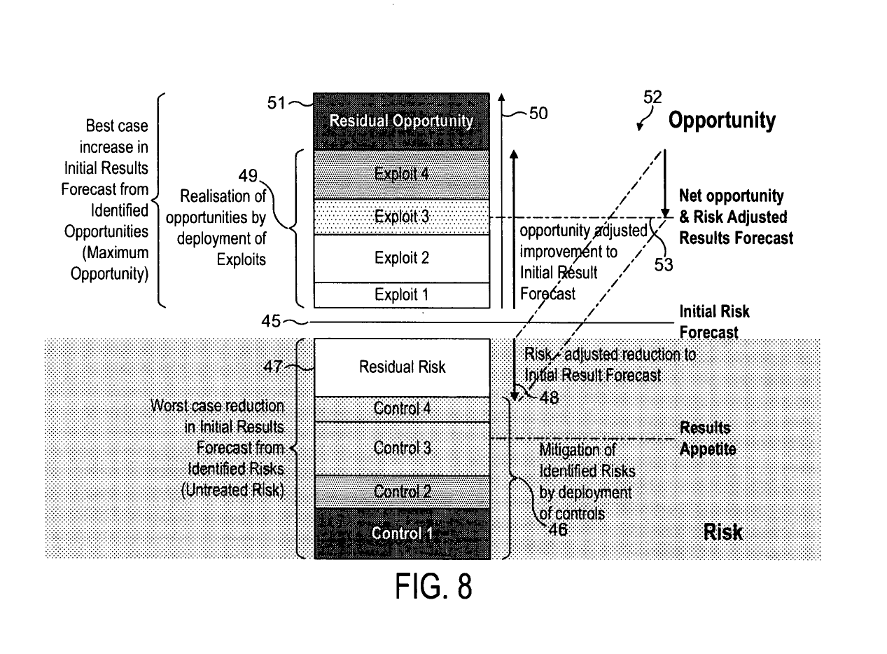

FIG. 8 shows a schematic representation of a business model including an Initial Results Forecast and both opportunities and risks; and,

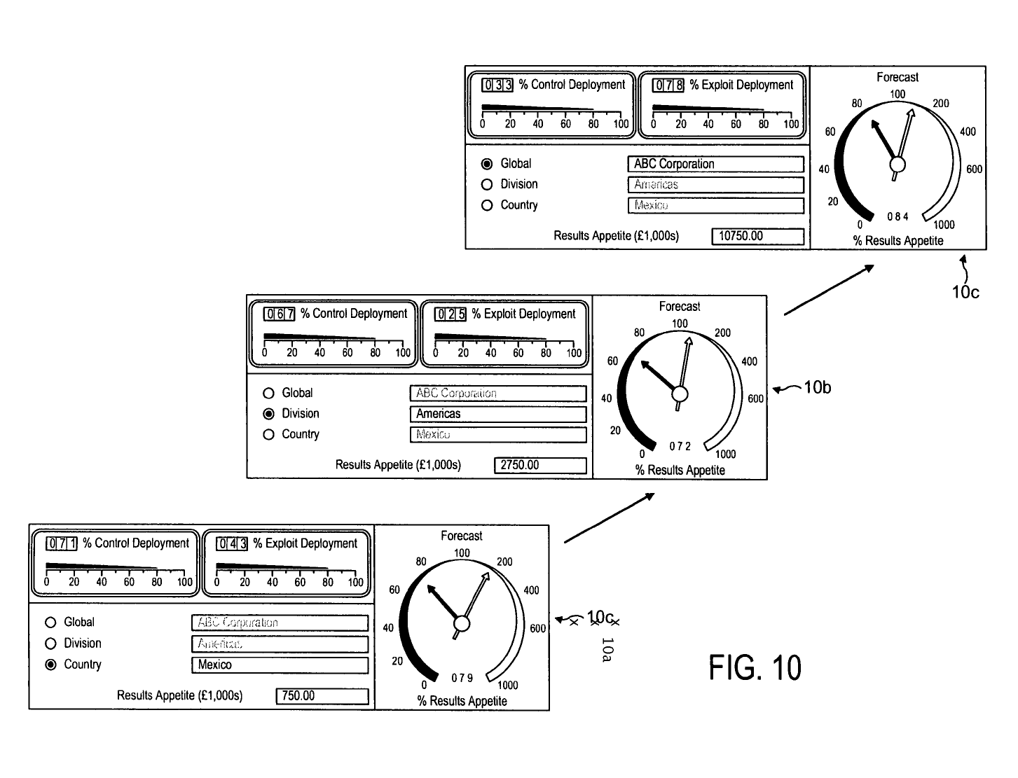

FIGS. 10 to 13 show examples of displays on a display device.

In the following specific description a first example is described in which general formulae and examples are given in respect of an embodiment used only to calculate risk and its management. These will be exemplified by a specific example with example values for various parameters. However, it will be understood that this is only one example and that the methods, systems and apparatus described herein are of wide applicability.

The specific example is one in which an organisation operates in a number of countries. Risk is calculated for an instance at a first level of hierarchy, e.g. for one country at a country level (e.g. a “Country” view, for Mexico for example). That risk is then aggregated with risk(s) calculated for one or more other instances at the same level, e.g. for other countries in a Division (e.g. with other North, Central and South American countries). This gives an aggregate view of that level (e.g. a “Division” view, here for the Americas). That level of risk (here, the Division view) is then aggregated with risk from other instances at the same level of the hierarchy (e.g. for other divisions, such as Europe, Africa, Pacific Rim countries, etc.). This gives an aggregate view of that level (e.g. a “Global” view), etc.

It is to be noted that the present invention in its broadest aspects is not limited to any particular number of layers or levels of aggregation, nor to the labels described herein for the specific example (e.g. Country, Division, Global), nor to any particular type or category of risk.

### Inputs

Residual risk and percentage control deployment are calculated initially at the lowest level in the hierarchy (Mexico in the above example). The inputs to the calculation are:

(i) data relating to untreated risks, i.e. “risks before the deployment of controls to treat the risk”, and
(ii) data relating to controls that treat the risk.

It should be noted that risk can be described in many different terms. As an example, a risk can be described in terms of the threat to an asset, e.g. the threat of explosion at an oil refinery, whether through accident or terrorist activity for example. Controls can similarly be described in many different terms. As an example, a control can be described as a control to an asset, e.g. disaster recovery plans for an oil refinery in the event of some explosion or security to reduce the risk of an attack on an oil refinery.

### Untreated Risks

One set of inputs to the calculation are a series of “n” untreated risks (UR): UR₁, UR₂ . . . URₙ. Untreated risks, i.e. risks to which no controls to mitigate the risks are applied, are calculated by multiplying the untreated impact (UI) that could result if the risk was to materialise (i.e. the severity of the risk, given in some suitable terms, such as an absolute number or value) by the untreated likelihood (UL) that the risk will materialise in a certain period, such as the next 12 months (i.e. the probability that the risk will occur). So:

$${UR}_{1} = {UI}_{1} * {UL}_{1}$$

$${UR}_{2} = {UI}_{2} * {UL}_{2}$$

$$…$$

$${UR}_{n} = {UI}_{n} * {UL}_{n}$$

A further dimension may be provided since a risk, if it materializes, can give rise to a range of different types of impact. For example, a risk to information (such as unauthorized use) might result in different impacts arising from a breach of information confidentiality, loss of information integrity or unavailability of information. Similarly the likelihood of the risk materializing and causing impact might be different for each of the different impact types. The subscript “p” used herein denotes up to “p” different impact types for each risk:

URₙₚ=UIₙₚ*ULₙₚ

### Controls

Controls (C) act to reduce untreated risks. For example, a control may be a disaster recovery plan in the event of a disaster at a manufacturing plant or an oil refinery, which operates to mitigate the impact of a risk. As another example, a control may be a measure that is put in place to reduce the likelihood that the risk will materialise, e.g. increasing security at a manufacturing plant or an oil refinery, the application of digital rights management (DRM) to electronic documents, etc.

Each untreated risk may be acted on by up to “m” controls. Each control may reduce the untreated risk in relation to one or more impact types in different ways, which will depend on for example:

(i) the percentage risk reduction (RR) provided by the control for the impact type against the risk. The percentage risk reduction provided by control “m” against risk “n” for impact type “p” is denoted as RRₘₙₚ;
(ii) the percentage deployment (D) of the control; and,
(iii) the adjusted percentage deployment (AD) of the control which takes account of the percentage deployment of other controls on which the control depends.

It should be noted that each control may mitigate multiple risks in different ways for different impact types.

### Calculating Residual Risk

Residual risk is calculated in the preferred embodiment as follows.

The following steps are carried out for each Risk (n)-Impact Type (p) relationship:

### (1) Calculate the Untreated Risk for the Impact Type:

URₙₚ=UIₙₚ*ULₙₚ

### (2) Calculate the Potential Residual Risk (Pot Res Risk) Level by Repeatedly Applying the Risk Reduction Percentage for Each Applicable Control, RRₘₙₚ:

Pot Res Riskₙₚ=URₙₚ*(1−RR₁ₙₚ)*(1−RR₂ₙₚ* . . . *(1−RRₘₙₚ)

### (3) Calculate the Total Risk Reduction Space (RRS), I.E. the Difference Between the Untreated Risk Level and the Potential Residual Risk Level:

RRSₙₚ=URₙₚ−Pot Res RiSkₙₚ

It is “within” this space that the applicable controls need to be effectively deployed in order to reduce the Untreated Risk Level down to the Potential Residual Risk Level.

### (4) Calculate the Size of Each “Slice” of the Risk Reduction Space, I.E. Risk Reduction Space/Untreated Risk Level:

Slice RRSₙₚ=RRSₙₚ/URₙₚ

Each Control is responsible for reducing to zero, or at least minimising, the number of slices that fall within its allocated part of the Space, based on its Relative Risk Reduction percentage as compared with other Controls.

(5) Calculate the Total of all of the Risk Reductions from all the Applicable Controls:

Total RRₙₚ=RR₁ₙₚ+RR₂ₙₚ+ . . . +RRₘₙₚ

Then, the following steps are carried out for each applicable Control (Cₘₙₚ):

(6) Calculate the Percentage Contribution of the Total Risk Reduction from Each Control, Based on the Individual Risk Reduction Metrics, as a Percentage of the Total:

RRₘₙₚContribution=RRₘₙₚ/Total RRₙₚ

### (7) Multiply the Risk Reduction Contribution by the Untreated Risk Level to Give the Relative Risk Reduction of Each Control:

Relative RRₘₙₚ=RRₘₙₚContribution*URₙₚ

(8) Multiply this by the Slice Size:

=Relative RRₘₙₚ*Slice RRSₙₚ

(9) Take into Account the Adjusted Control Deployment Percentage (AD) (See Further Below) to Calculate the Risk Reduction (Risk Red) from Each Control:

Risk Redₘₙₚ=ADₘ*Relative RRₘₙₚ*Slice RRSₙₚ

(10) Add Up the Risk Reductions from all Controls that Protect Against the Risk-Impact Type to Calculate the Total Risk Reduction:

Total Risk Redₙₚ=Risk Red₁ₙₚ+Risk Red₂ₙₚ+ . . . +Risk Redₙₚ

(11) Calculate the Residual Risk (Res Risk) for the Risk-Impact Type by Subtracting the Total Risk Reduction from the Untreated Risk:

Res Riskₙₚ=URₙₚ−Total RRedₙₚ

### (12) Calculate the Residual Risk (Res Risk) for the Risk by Adding Together the Residual Risks for Each Risk-Impact Type:

Res Riskₙ=Res Riskₙ₁+Res Riskₙ₂+ . . . +Res Riskₙₚ

### (13) Calculate the Residual Risk for the Lowest Level in the Hierarchy (E.G. Mexico in the Specific Example Mentioned Above) by Adding Together the Residual Risks for Each Risk:

Res Risk=Res Risk₁+Res Risk₂+ . . . +Res Riskₙ

Residual Risk as a percentage of risk appetite is calculated by reference to the Risk Appetite:

Residual Risk %(Risk Appetite)=(Res Risk/Risk Appetite)*100

The Risk Appetite is input by a user according to a number of factors and may be varied by the user at any particular time accordingly.

Future Residual Risk can be forecast by estimating the values of the parameters described above at selected points in the future.

To exemplify this further, a worked example for calculating Residual Risk will be given.

Suppose that a Risk 1 is mitigated by Controls 1, 2, 3 and 4 as follows:

| | Impact | Impact | Impact | | Impact |
|---|---|---|---|---|---|
| | Type 1 | Type 2 | Type 3 | . . . | Type n |
| Risk 1 | | | | | |
| Untreated | 1000 | 1500 | 670 | . . . | 1450 |
| Impact | | | | | |
| Untreated | 67% | 75% | 23% | . . . | 7% |
| Likelihood | | | | | |
| Control 1 | | | | | |
| Risk | 75% | 55% | 0% | . . . | 30% |
| Reduction % | | | | | |
| Adjusted % | 80% | | | | |
| Deployment | | | | | |
| Control 2 | | | | | |
| Risk | 55% | 98% | 60% | . . . | 20% |
| Reduction % | | | | | |
| Adjusted % | 50% | | | | |
| Deployment | | | | | |
| Control 3 | | | | | |
| Risk | 56% | 34% | 12% | . . . | 70% |
| Reduction % | | | | | |
| Adjusted % | 34% | | | | |
| Deployment | | | | | |
| Control 4 | | | | | |
| Risk | 12% | 45% | 60% | . . . | 87% |
| Reduction % | | | | | |

| | |
|---|---|
| Adjusted % | 65% |
| Deployment | |

For Risk 1—Impact Type 1:

### (1) Calculate the Untreated Risk for the Impact Type:

URₙₚ=UIₙₚ*ULₙₚ

UR₁₁=1000*67%=670

### (2) Calculate the Potential Residual Risk (Pot Res Risk) Level, by Repeatedly Applying the Risk Reduction Percentage for Each Applicable Control, RRₘₙₚ:

$$Pot Res {Risk}_{np} = {UR}_{np} * ( 1 - {RR}_{1 np} ) * ( 1 - {RR}_{2 np} ) * … * ( 1 - {RR}_{mnp} )$$

$$\begin{matrix}Pot Res {Risk}_{11} = 670 * ( 1 - 75 \% ) * ( 1 - 55 \% ) * ( 1 - 56 \% ) * ( 1 - 12 \% ) \\ = 670 * 25 \% * 45 \% * 44 \% * 88 \% \\ = 29.19\end{matrix}$$

### (3) Calculate the Total Risk Reduction Space (RRS), I.E. the Difference Between the Untreated Risk Level and the Potential Residual Risk Level:

$$\begin{matrix}{RRS}_{11} = 670 - 29.19 \\ = 640.81\end{matrix}$$

It is “within” this space that the applicable Controls need to be effectively deployed to reduce the Untreated Risk Level down to the Potential Residual Risk Level.

### (4) Calculate the Size of Each “Slice” of the Risk Reduction Space, I.E. Risk Reduction Space/Untreated Risk Level:

$$\begin{matrix}Slice {RRS}_{11} = 640.81 / 670 \\ = 0.96\end{matrix}$$

Each Control will then be responsible for reducing to zero the number of slices that fall within its allocated part of the Space, based on its relative Risk Reduction percentage as compared with other controls.

(5) Calculate the Total of all the RRS from all the Applicable Controls:

$$Total {RR}_{np} = {RR}_{1 np} + {RR}_{2 np} … + {RR}_{mnp}$$

$$\begin{matrix}Total {RR}_{11} = 75 \% + 55 \% + 56 \% + 12 \% \\ = 198 \%\end{matrix}$$

Now repeat for each applicable Control (Cₘₙₚ):

(6) Calculate the Percentage Contribution of the Total Risk Reduction from Each Control, Based on the Individual Risk Reduction Metrics, as a Percentage of the Total:

RRₘₙₚContribution=RRₘₙₚ/Total RRₙₚ

RR₁₁₁Contribution=75%/198%=38%

RR₂₁₁Contribution=55%/198%=28%

RR₃₁₁Contribution=56%/198%=28%

RR₄₁₁Contribution=12%/198%=6%

### (7) Multiply the Risk Reduction Contribution by the Untreated Risk Level, to Give the Relative Risk Reduction of Each Control:

Relative RRₘₙₚ=RRₘₙₚContribution*URₙₚ

Relative RR₁₁₁=38%*670=255

Relative RR₂₁₁=28%*670=188

Relative RR₃₁₁=28%*670=188

Relative RR₄₁₁=6%*670=40

(8) Multiply this by the Slice Size:

=Relative RRₘₙₚ*Slice RRSₙₚ

=(for Control 1)255*0.96=245

=(for Control 2)188*0.96=180

=(for Control 3)188*0.96=180

=(for Control 4)40*0.96=38

(9) Take into Account the Adjusted Control Deployment Percentage (AD) to Calculate the Risk Reduction (Risk Red) from Each Control:

Risk Redₘₙₚ=ADₘ*Relative RRₘₙₚ*Slice RRSₙₚ

Risk Red₁₁₁=80%*245=196

Risk Red₂₁₁=50%*180=90

Risk Red₃₁₁=34%*180=61

Risk Red₄₁₁=65%*38=25

(10) Add Up the Risk Reductions from all Controls that Protect Against the Risk-Impact Type to Calculate the Total Risk Reduction:

Total Risk Redₙₚ=Risk Red₁ₙₚ+Risk Red₂ₙₚ . . . +Risk Redₙₚ

Total Risk Red₁₁=196+90+61+25=372

(11) Calculate the Residual Risk (Res Risk) for the Risk-Impact Type by Subtracting the Total Risk Reduction from the Untreated Risk:

Res Riskₙₚ=URₙₚ−Total RRedₙₚ

Res Risk₁₁=670−372=298

### (12) Calculate the Residual Risk (Res Risk) for the Risk by Adding Together the Residual Risks for Each Risk-Impact Type:

Res Riskₙ=Res Riskₙ₁+Res Riskₙ₂+ . . . +Res Riskₙₚ

(Not calculated in this worked example.)

(13) Calculate the Residual Risk for the Lowest Level in the Hierarchy (E.G. Mexico in this Specific Example) by Adding Together the Residual Risks for Each Risk:

Res Risk=Res Risk₁+Res Risk₂+ . . . +Res Riskₙ

(Not calculated in this worked example.)

### Calculating Adjusted Control Deployment

Adjusted Control Deployment is calculated in the preferred embodiment as follows:

Assume Control Cₘ is:

X₁% dependent on C₁, and

X₂% dependent on C₂, and

. . . .

Xₜ% dependent on Cₜ

The Deployment of Control Cₘ is denoted as Dₘ. The Adjusted Deployment of Control Cₘ is denoted as ADₘ and calculated as follows:

ADₘ=Dₘ*(1−((1−AD₁)*X₁%))*(1−((1−AD₂)*X₂%))* . . . *(1−((1−ADₜ)*Xₜ%))

It will be understood here that as one follows through the trail of dependencies of Controls on other Controls, there will eventually be a Control that does not depend on any other Control. For this Control, the Adjusted Deployment is set equal to the Deployment, allowing a starting point for the calculation of the Adjusted Deployments of the other Controls to be made. The Deployment of a Control is a user-input amount.

It should also be noted that X₁%+X₂%+ . . . +Xₜ% must not exceed 100%.

It may also be noted that t<the total number of Controls since a Control cannot be dependent on itself (or indeed dependent on Controls that are in turn dependent on the original Control).

A worked example for calculating Adjusted Control Deployment will now be given to exemplify this further.

Suppose that Control 1 is dependent on Controls 2, 3, 4 and 5 and further that the Deployment percentage of Control 1 is 95%. The Adjusted Deployment percentage and percentage Dependency on Control 1 of Controls 2, 3, 4 and 5 are shown below:

Control

| | 2 | 3 | 4 | 5 |
|---|---|---|---|---|
| % Adjusted | 75% | 78% | 56% | 100% |
| Deployment | | | | |
| % Dependency | 15% | 5% | 12% | 20% |
| of Control 1 | | | | |
| on Control | | | | |

The Adjusted Deployment of Control 1 is calculated as:

95%*(1−((1−75%)*15%))*(1−((1−78%)*5%))* (1−((1−56%)*12%))*(1−((1−100%)*20%))=95%*(1−(25%*15%))*(1−(22%*5%))*(1−(44%*12%))*(1−(0%*20%))=95%*(1−3.75%)*(1−1.1%)*(1−5.28%)*(1−0%)=95%*96.25%*98.9%*94.72%*100%=85.25%

### Calculating Average Adjusted Control Deployment

If there are “m” controls protecting against Risk “n”, the average adjusted deployment of all Controls that protect against Risk “n” is calculated by taking the mean of the individual adjusted control deployments:

ADₙ=(AD₁ₙ+AD₂ₙ+ . . . ADₘₙ)/m

In FIG. 1 there is shown an example of a display device 1 having displayed thereon a display window 2 for graphically representing various data. In the example shown, the display window 2 can display information relating to and/or obtained by the preferred embodiments described above. Alternatively or additionally, the display window 2 can display such information in the case that at least some of that information is obtained by other methods.

The display window 2 includes a part-circular gauge 3, which mimics an analogue-type gauge, having first and second pointers 4,5.

In the example shown, the position of the first pointer 4 is arranged to represent the current residual risk as a percentage or proportion of “risk appetite”, which is input by a user according to a number of factors and may be varied by the user at any particular time accordingly. In one specific example described, the current residual risk is the finally calculated Residual Risk described above.

In the example shown, the position of the second pointer 5 is arranged to represent the minimum remaining risk in the case that all applicable controls that can be applied to mitigate the risk are fully applied. In one specific example, this minimum remaining risk corresponds to the Potential Residual Risk described above (i.e. the Potential Residual Risk given the current Controls and their Risk Reduction percentages).

A part-circular gauge 3 is most preferred for this as it is easy to view and interpret, allowing the user to obtain a very quick understanding of the current level of risk or other effects and also how varying various controls or other measures that affect the risk alter the current level of risk. It will be understood however that other representations are possible, such as a linear gauge.

The display window 2 of this example also includes a display 6 that indicates graphically the average amount of deployment of controls that is currently applied to mitigate risk. In this example, the average amount of deployment is presented as a percentage of the maximum available amount of deployment of the controls. In this example, the average amount of deployment is displayed on a linear gauge 6.

The display window 2 of this example also includes a display window 7 that displays data relating to risk appetite. In this example, risk appetite is displayed in monetary terms though other units may be used as appropriate and/or desired.

Last, the display window 2 of this example also includes selection boxes 8,9,10 that correspond to different levels in the hierarchy for which the information is to be presented. In this case, the different levels corresponding to the selection boxes 8,9,10 are different levels at which risk is considered. Referring to the specific example mentioned above in which an organisation operates in a number of countries, the first level to which the first selection box 8 corresponds may be the country level; the second level to which the second selection box 9 corresponds may be the division level (for which the results from several countries are aggregated; and the third level to which the third selection box 10 corresponds may be the global level (for which the results from several divisions are aggregated).

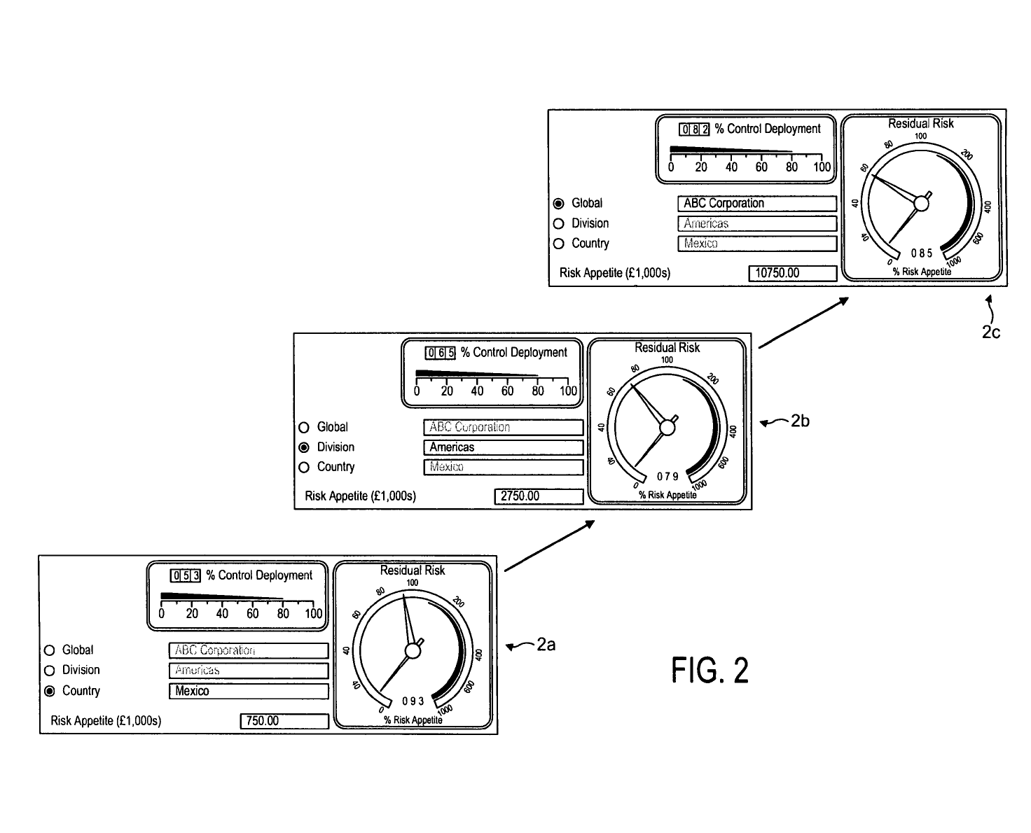

As shown in FIG. 2, the user can select display of these different levels by checking of the corresponding selection box 8,9,10. Thus, selection of the first selection box 8 causes the display window 2a to be displayed to display the relevant data for the country level; selection of the second selection box 9 causes the display window 2b to be displayed to display the relevant data for the division level; and selection of the third selection box 10 causes the display window 2c to be displayed to display the relevant data for the global level. It may be noted for example that the risk appetite shown in the window 7 is the risk appetite that pertains to the level of the hierarchy selected by the user by checking of the corresponding selection box 8,9,10. Similarly, checking the selection box 8,9,10 also results in the gauge 3 and the barometer 6 displaying the data pertaining to the selected level in the hierarchy.

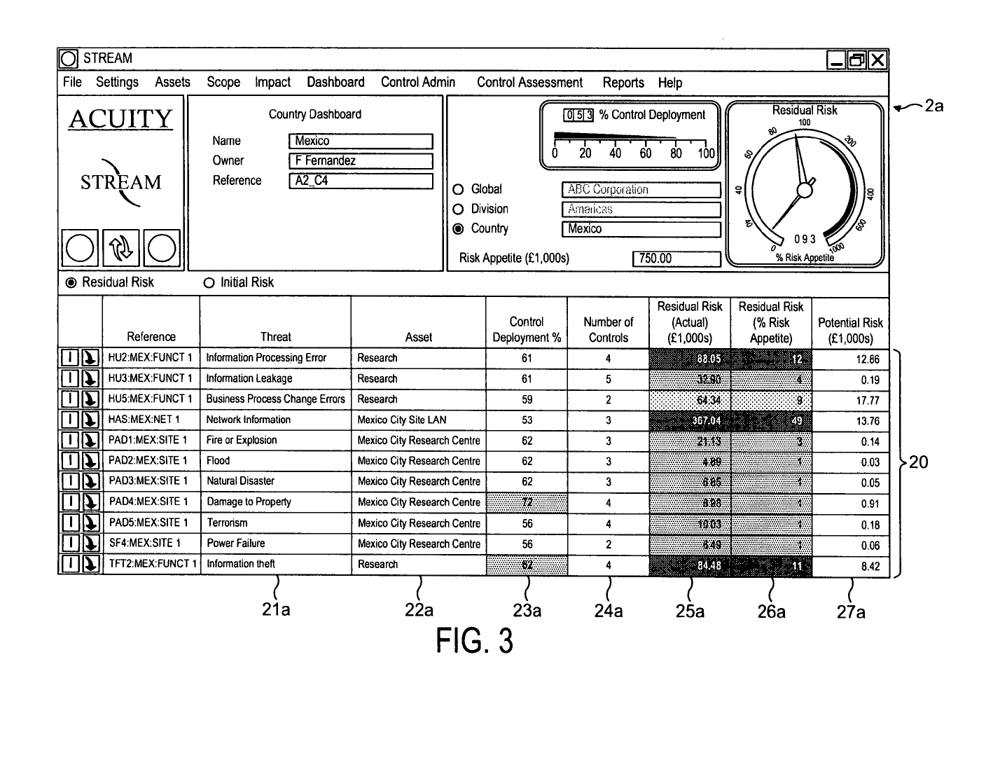

Referring now to FIG. 3, at the lowest level in the hierarchy, in the preferred embodiment information relating to all of the risks that affect that level is displayed in information fields 20a. In this example, the risks are displayed in terms of threats 21a to assets 22a. The (average) amount of deployment 23a of the relevant control(s) to those risks is also displayed. There can also be displayed the number of controls 24a that are applicable to each risk, the actual residual risk 25a relating to each risk, the residual risk 26a as a percentage of risk appetite, and the potential risk 27a.

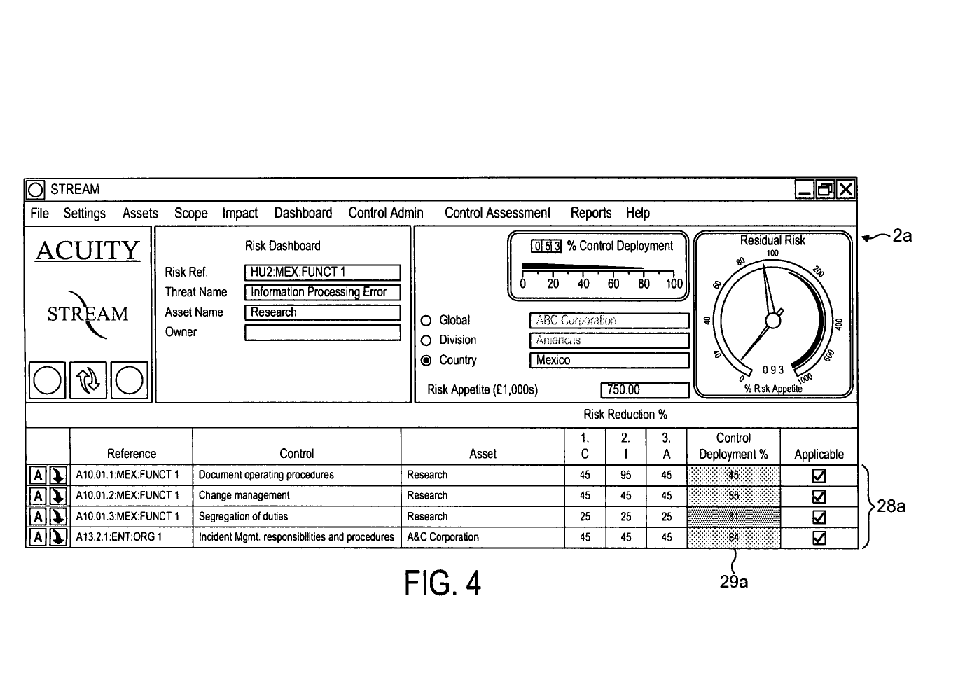

Referring now to FIG. 4, by individually selecting rows in the information fields 20a in the display of FIG. 3, the user can then be presented with information fields 28a that relate to all of the controls that are applicable to the corresponding risk. The information that is displayed here includes in particular the Percentage Adjusted Deployment 29a of each control.

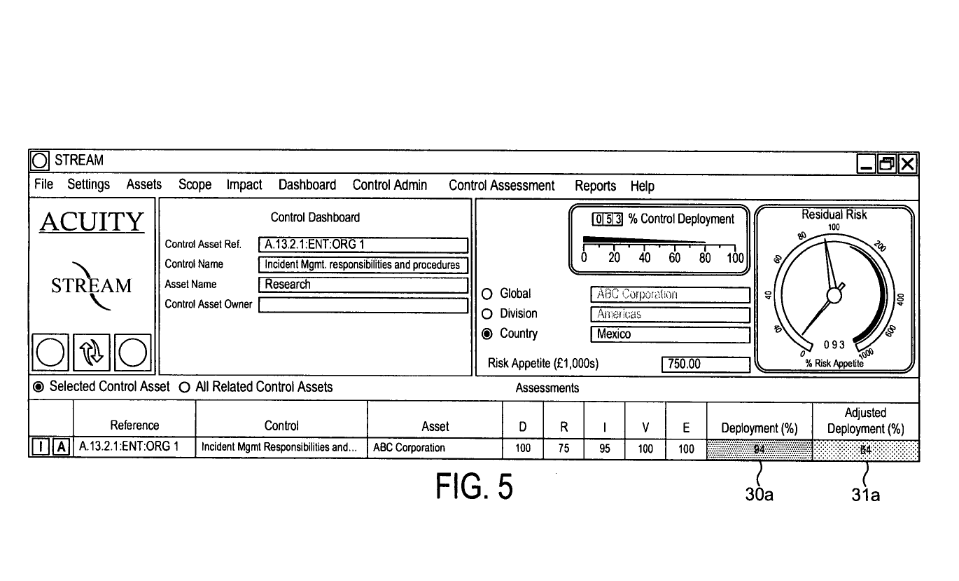

Referring now to FIG. 5, by individually selecting rows in the information fields 28a in the display of FIG. 4, the user can then be presented with more information about the corresponding control. The information that is displayed here in this preferred example includes in particular the percentage deployment 30a of each control and the percentage adjusted deployment 31a of each control, the adjusted deployment here in this example being the adjusted deployment that is obtained in the preferred method described above.

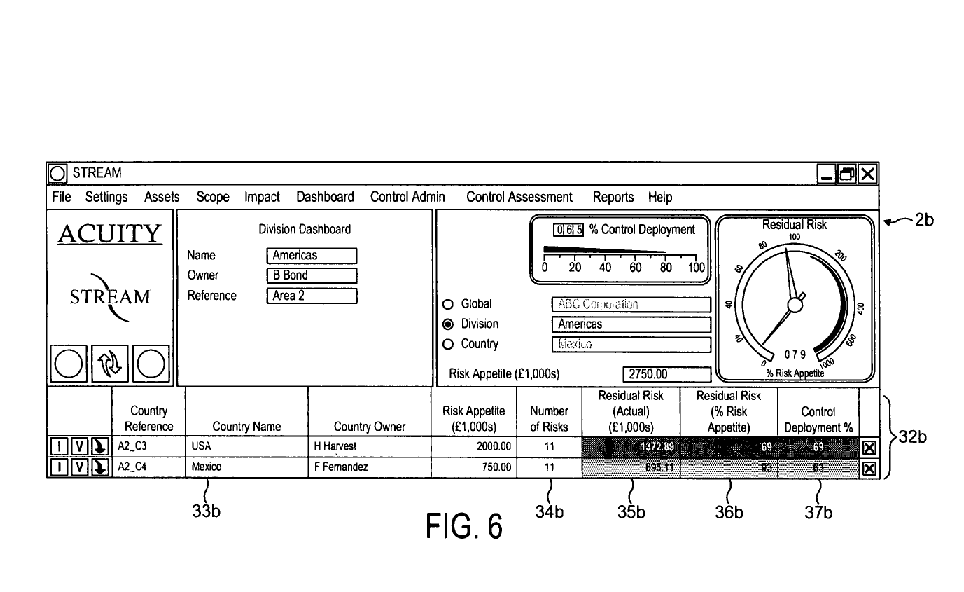

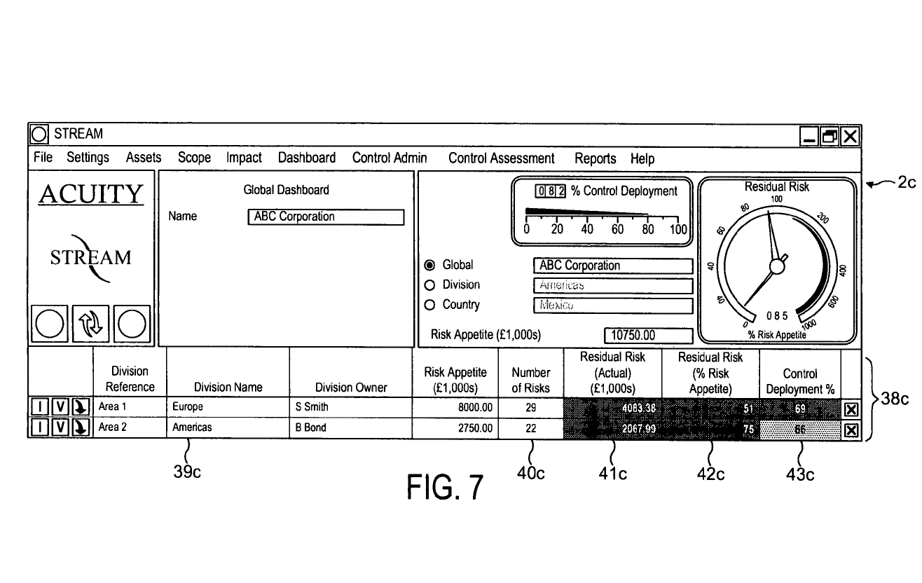

FIGS. 6 and 7 show examples of displays for higher levels in the hierarchy. FIG. 6 shows the display 2b for the second (“division”) level and information 32b relating thereto, which are presented in response to the user selecting the second selection box 9. The information 32b includes the names of the “items” 33b under that level (here, the “items” being the countries) and the number of risks 34b, the actual residual risk 35b, the residual risk as a percentage of risk appetite 36b, and the average control deployment 37b corresponding thereto. FIG. 7 shows a similar display for the third (“global”) level and information 38c relating thereto, which are presented in response to the user selecting the third selection box 10. The information 38c includes the names of the “items” 39c under that level (here, the “items” being the divisions) and the number of risks 40c, the actual residual risk 41c, the residual risk as a percentage of risk appetite 42c, and the average control deployment 43c corresponding thereto.

In the example described above, the risk and the effect of controls on the risk is calculated and quantified in a way that enables the risk then to be managed. There will now be described a second example in which risk and opportunity with respect to an Initial Results Forecast may be managed. Like in the example above with respect only to risk, in the following specific description, general formulae and examples will be given. These will be exemplified by a specific example. However, it will be understood that this is only one example and that the methods, systems and apparatus described herein are of wide applicability.

In general in this second example, the risk is calculated as it is above when risk alone is considered. However, in addition to the calculation of risk, a calculation of opportunity is made. Whereas for risk the aim is to minimise the risk and so controls are used to do so, for opportunities the aim would normally be to maximise the opportunities. Accordingly, as an analogy to the risks and controls described above the concept of opportunity and exploits is now introduced. Furthermore, since both risks and opportunities are considered, the concept of an “Initial Results Forecast” is introduced as, preferably, it is with respect to the Initial Results Forecast that the combined effect of the risks and opportunities can be seen and judged.

FIG. 8 shows a schematic representation of a business model in which an Initial Results Forecast is affected by both risks and opportunities to arrive at a Net Opportunity and Risk Adjusted Results forecast. An Initial Results Forecast 45 is provided which represents the results forecast for, say, a business before the effects of risks and opportunities are taken into account. Starting, for the sake of explanation only, with risks 46, it can be seen that the risks 46 lower the Initial Results Forecast 45. Controls 1 to 4 are shown having the effect of reducing the negative effect of the risks up to a level of the Residual Risk 47. The arrow 48 shows the risk-adjusted reduction to the Initial Results Forecast.

Next, the effect of opportunity is shown on the Initial Results Forecast or rather on the risk-adjusted reduction to the Initial Results Forecast. Four exploits 49 (Exploits 1 to 4) are shown acting to realise the opportunity and to achieve an increase in the Initial Results Forecast. The arrow 50 shows the best case increase, the “Maximum Opportunity” from the identified opportunities, in the Initial Results Forecast. With all four exploits activated, the opportunity adjusted improvement to the Initial Results Forecast 52 is achieved.

To determine the Net Opportunity and Risk Adjusted Results forecast 53, the amounts of the opportunity adjusted improvement to the Initial Results Forecast 52 and the risk-adjusted reduction to the Initial Results Forecast (a negative number) are added to the Initial Results Forecast 45 to give the final Net Opportunity and Risk Adjusted Results forecast 53. Thus, it will be appreciated that either the opportunity-adjusted improvement or the risk-adjusted reduction can be calculated first since it will not affect the final result once all factors are summed.

### Inputs

Forecast results and % exploit deployment are calculated initially at the lowest level in the hierarchy. The “hierarchy” levels are as described above with reference to risk only. The inputs to the calculation are:

(i) The Initial Results Forecast for the time period, i.e. the results forecast for the time period in question before risks and opportunities are taken into account.
(ii) Data relating to the best case improvement on the Initial Results Forecast that could result from the identified opportunities if suitable exploits are identified and deployed successfully (the Maximum Opportunity).
(iii) Data relating to exploits that enhance the opportunities.
(iv) Data relating to the (worst case) reduction on the Initial Results Forecast that could result from the identified risks if no controls are applied to treat the risks (the Untreated Risk).
(v) Data relating to controls that treat the risks.

As above, risks and opportunities can be described in many different terms. For example, an opportunity can be described in terms of the opportunity to improve an asset, e.g. the opportunity to improve productivity at an oil refinery. An exploit can be described as an exploit to asset, e.g. flexible working arrangements at an oil refinery. This is a means or way that the opportunity to improve the productivity at an oil refinery can be realised. As above, risks and controls can be described in terms of the threats and controls to an asset.

Starting from the Initial Results Forecast it is necessary to calculate both the best case increase from all the identified opportunities and the worst case reduction from all the risks in the Initial Results Forecast.

Best-Case Improvement on Initial Results Forecast from Identified Opportunities

The inputs to the calculation are a series of ‘x’ opportunities: O¹, O² . . . O^{x}.

The Maximum Opportunity (MO) is calculated by multiplying the Result Improvement (RI) that could result if the opportunity was to materialise by the likelihood that the opportunity will materialise (OL). So:

$${MO}^{1} = {RI}^{1} * {OL}^{1}$$

$${MO}^{2} = {RI}^{2} * {OL}^{2}$$

$$⋮$$

$${MO}^{x} = {RI}^{x} * {OL}^{x}$$

A further dimension may be provided since an opportunity can potentially give rise to a range of different types of result improvement. For example, improved productivity at an oil refinery might deliver different better results relating to cost reduction, higher output, fewer accidents etc. The superscript ‘p’ denotes up to ‘p’ different results types. Thus, the equations above become of the form:

MO^{xp}=RI^{xp}*OL^{xp}

A further dimension is then provided since the results arising from exploiting opportunities may vary between time periods, e.g. results may be low in initial periods but higher in later periods. The superscript ‘q’ denotes up to ‘q’ different time periods. Thus, the equation for MO becomes:

MO^{xpq}=RI^{xpq}*OL^{xpq}

### Exploits

Exploits (E) act to realise opportunities. Each opportunity may be acted on by up to ‘y’ Exploits. Each exploit may help to realise the opportunity in relation to one or more results types in different ways, which will depend on the following factors:

(i) % Opportunity Realisation Metric (ORM) provided by the Exploit for the results type.

This is a measurement of the extent to which an exploit can realise the opportunity and provide a results improvement. The % Opportunity Realisation Metric provided by Exploit ‘y’ for Opportunity ‘x’ for results type ‘p’ in time period ‘q’ is denoted as ORM^{yxpq}. This is analogous to the percentage Risk Reduction (RR) referred to above in relation to controls on risks;

(ii) The % deployment of the Exploit (DE); and
(iii) The adjusted % deployment of the Exploit (ADE) which takes account of the % deployment of other exploits on which the Exploit depends.

Each Exploit may help to realise multiple opportunities in different ways for different Results Types.

Worst-Case Reduction on Initial Results Forecast from Identified Risks

The worst case reduction on Initial Results Forecast is also determined based on the identified risks. This calculation is substantially the same as that described above in the example in which only risks are taken into account.

The inputs to the calculation are a series of ‘n’ risks: R¹, R² . . . Rⁿ. The Untreated Risks (UR) are calculated by multiplying the Results Reduction (RR) that could result if the risk was to materialise by the likelihood that the risk will materialise (RL).

As with opportunities, a further dimension is provided since a risk can potentially give rise to a range of different types of result reduction and the result reduction may vary between time periods. The superscript ‘p’ denotes up to ‘p’ different results types and the superscript ‘q’ denotes up to ‘q’ different time periods. The equation for an untreated risk for a type of effect p and over a time period q therefore becomes

UR^{npq}=RR^{npq}*RL^{npq}

### Controls on Risks

As explained above, controls (C) act to reduce untreated risks. Each untreated risk may be acted on by up to ‘m’ Controls. Each control may reduce the untreated risk in relation to one or more results types in different ways, which will depend on:

(i) The % risk reduction metric (RRM) provided by the Control for the results type against the risk. The % Risk Reduction Metric provided by Control ‘m’ against Risk ‘n’ for results type ‘p’ in time period q, is denoted as RRM^{mnpq};
(ii) The % deployment of the Control (DC); and
(iii) The adjusted % deployment of the Control (ADC) which takes account of the % deployment of other controls on which the Control depends.

Each Control may mitigate multiple risks in different ways for different Results Types. It is important that the deployment of one control may be affected by the deployment of one or more other controls.

### Calculating Improvements in Results Forecast

Improvements in Results Forecast, either for use in combination with a reduction due to risks or alone, are calculated using the following formula.

The following steps are repeated for each

Opportunity (x)/Results Type (p)/Time Period (q) relationship.

### (1) Calculate the Maximum Opportunity for the Results Type/Time Period, E.G.

MO^{xpq}=RI^{xpq}*OL^{xpq}

### (2) Calculate the Potential Residual Opportunity (Pot Res Opp), by Repeatedly Applying the % Opportunity Realisation Metric for Each Applicable Exploit, ORM^{yxpq}

Pot Res Opp^{xpq}=MO^{xpq}*(1−ORM^{1xpq})*(1−ORM^{2xpq}) . . . * (1−ORM^{yxpq})

The Potential Residual Opportunity is the remaining opportunity that still remains to be achieved even if all of the Exploits were 100% deployed.

### (3) Calculate the Total Result Improvement Space (RIS), I.E. Difference Between the Maximum Opportunity Level, and the Potential Residual Opportunity

RIS^{xpq}=MO^{xpq}−Pot Res Opp^{xpq}

It is ‘within’ this space that the applicable Exploits need effectively to be deployed to increase the actual result up to the level of the Potential Result Improvement:

The Potential Result Improvement(Pot Result Impr^{xpq})=RIS^{xpq}

### (4) Calculate the Size of Each ‘Slice’ of the Result Improvement Space (RIS), I.E. Result Improvement Space/Maximum Opportunity:

Slice RIS^{xpq}=RIS^{xpq}/MO^{xpq}

Each Exploit is then responsible for filling the number of slices that fall within its allocated part of the Result Improvement Space, based on its relative % Opportunity Realisation Metric as compared with other Exploits.

(5) Calculate the Total of all the ORMs from all the Applicable Exploits:

Total ORM^{xpq}=ORM^{1xpq}+ORM^{2xpq} . . . +ORM^{yxpq}

Now repeat for each applicable Exploit (E^{yxpq})
(6) Calculate the Percentage Contribution of the Total Opportunity Realisation from Each Exploit, Based on the Individual Opportunity Realisation Metrics, as a Percentage of the Total:

OR^{yxpq}Contribution=ORM^{yxpq}/Total ORM^{xpq}

### (7) Multiply the Opportunity Realisation Metric Contribution by the Potential Result Improvement, to Give the Relative Opportunity Realisation of Each Exploit:

Relative Opp Real^{yxpq}=OR^{yxpq}Contribution*Pot Result Impr^{xpq}

(8) Multiply this by the Slice Size, as Above:

Relative Opp Real^{yxpq}*Slice RIS^{xpq}

(9) Take into Account the Adjusted Exploit Deployment % (AED) to Calculate the Opportunity Realisation (Opp Real.) from Each Exploit:

Opp Real^{yxpq}=AED^{yq}*Relative OR^{yxpq}*Slice RIS^{xpq}

(10) Add Up the Opportunity Realisations from all Exploits that Realise the Opportunity/Results Type to Calculate the Total Forecast Result Improvement:

Forecast Result Improvement^{xpq}=Opp Real^{1xpq}+Opp Real^{2xpq} . . . +Opp Real^{mxpq}

### (11) Calculate the Forecast Result Improvement (For Res Imp) for the Opportunity by Adding Together the Forecast Result Improvements for Each Opportunity/Results Type:

For Res Imp^{xq}=For Res Imp^{x1q}+For Res Imp^{x2q}+ . . . +For Res Imp^{xpq}

(12) Finally in this Stage, the Forecast Result Improvement is Calculated for the Lowest Level in the Hierarchy (E.G. Mexico in this Example) by Adding Together the Forecast Result Improvement for Each Opportunity:

For Res Imp^{q}=For Res Imp^{1q}+For Res Imp^{2q}+ . . . +For Res Imp^{nq}

### Calculating Reduction in Initial Results Forecast

The forecast reduction to the Initial Results Forecast is calculated using the following formula. In effect this is the reverse calculation described above and is the same as the calculation described above with respect to the example in which only risks are taken into account. In view of the similarity with the example above (for risks only) for brevity, all steps in the calculation will not now be repeated. The steps are substantially the same as those described above with the added dimension of a time period (q), as explained above with respect to opportunity.

The following steps are repeated for each

Risk (n)/Results Type (p)/Time Period (q) relationship.

Initially, the untreated risk is calculated for the results type/time period. Once analogous steps are undertaken as described above with respect to the example in which only risks are considered, the Forecast Result Reduction (For Res Red) for the Risk/Result Type is calculated by subtracting the Total Risk Reduction from the Untreated Risk:

For Res Red^{npq}=UR^{npq}−Total Risk Red^{npq}

The Forecast Result Reduction for the Risk is then calculated by adding together the Forecast Result Reductions for each Risk/Impact Type:

For Res Red^{nq}=For Res Red^{n1q}+For Res Red^{n2q}+ . . . +For Res Red^{npq}

The Forecast Result Reduction for the lowest level in the hierarchy (e.g. Mexico in the example) may then be calculated by adding together the Forecast Result Reduction for each Risk:

For Res Red^{q}=For Res Red^{1q}+For Res Red^{2q}+ . . . +For Res Red^{nq}

Once this has been done it is then possible to calculate a net opportunity and risk adjusted results forecast.

### Formula for Calculating Net Opportunity & Risk Adjusted Results Forecast

The forecast (opportunity & risk adjusted) Results Forecast (Res For) is calculated using the following formula (optionally repeated for each Time Period (q)):

(i) Add the Forecast Result Improvement (For Res Imp) to the Initial Results Forecast (Initial Res For) and subtract the Forecast Result Reduction (For Res Red):

Res For^{q}=Initial Res For^{q}+For Res Imp^{q}−For Res Red^{q}

The Results Forecast across all time periods may be calculated by adding together the Results Forecast for each time period:

Res For=Res For¹+Res For²+ . . . +Res For^{q}

Forecast Result as a percentage of an organisation's Results Appetite is calculated by reference to the Results Appetite:

Res For^{q}(% Results Appetite)=(Res For^{q}/Results Appetite^{q})*100

Or, for all time periods:

Res For(% Results Appetite)=(Res For/Results Appetite)*100

Thus, a method and calculation is provided by which a net opportunity and risk adjusted results forecast may be determined. The Results Appetite is input by a user according to a number of factors and may be varied by the user at any particular time accordingly. By varying the Results Appetite a user can see immediately how the risks and opportunities change accordingly. Future Residual Risk and opportunity can be forecast by estimating the values of the parameters described above at selected points in the future.

To exemplify this further, a worked example for calculating a net opportunity and risk adjusted results forecast is provided.

Suppose that an organisation has an Initial Results Forecast of £10 m for a Time Period 1.

Suppose also that an opportunity 1 in respect of the Initial Results Forecast exists which is realised by Exploits 1 and 2 and that a risk 1 exists which is mitigated by Controls 1 and 2.

All of the following example figures relate to Results Type 1 in Time Period 1.

| Opportunity | Results | | Results | | Results |
|---|---|---|---|---|---|
| 1 | Type 1 | Exploit 1 | Type 1 | Exploit 2 | Type 1 |
| Result | £1m | Opportunity | 70% | Opportunity | 45% |
| Improvement | | Realisation | | Realisation | |
| (RI) | | Metric | | Metric (ORM) | |
| | | (ORM) | | | |
| Opportunity | 50% | Adjusted | 60% | Adjusted | 80% |
| Likelihood | | Deployment | | Deployment of | |
| (OL) | | of the | | the Exploit | |
| | | Exploit | | (ADE) | |
| | | (ADE) | | | |
| | Results | | Results | | Results |
| Risk 1 | Type 1 | Control 1 | Type 1 | Control 2 | Type 1 |
| Result | £0.5m | Risk | 60% | Risk | 50% |
| Reduction | | Reduction | | Reduction | |
| (RR) | | Metric | | Metric (RRM) | |
| | | (RRM) | | | |
| Risk | 30% | Adjusted | 20% | Adjusted | 60% |
| Likelihood | | Deployment | | Deployment of | |
| (RL) | | of the | | the Control | |
| | | Control | | (ADC) | |
| | | (ADC) | | | |

### Formula for Calculating Improvement to Initial Results Forecast

First, in this example, the improvement to the Initial Results Forecast is calculated.

The following steps are repeated for each:

Opportunity (x)/Results Type (p)/Time Period (q) relationship.

The maximum opportunity for the results type/time period is calculated, e.g.:

MO^{xpq}=RI^{xpq}*OL^{xpq}

So, for Opportunity 1, results type 1 and time period 1,

MO¹¹¹=RI¹¹¹*OL^{xpq}

MO¹¹¹=£1 m*50%=£500,000

The Potential Residual Opportunity (Pot Res Opp) is calculated, by repeatedly applying the % Opportunity Realisation Metric for each applicable Exploit, ORM^{yxpq}:

$$Pot Res {Opp}^{xpq} = {MO}^{xpq} * ( 1 - {ORM}^{1 xpq} ) * ( 1 - {ORM}^{2 xpq} ) … * ( 1 - {ORM}^{yxpq} )$$

$$\begin{matrix} Pot Res {Opp}^{111} = {MO}^{111} * ( 1 - {ORM}^{1111} ) * ( 1 - {ORM}^{2111} ) \\ = £0 .5 m * ( 1 - 70 \% ) * ( 1 - 45 \% ) \\ = £82 , 500\end{matrix}$$

The Potential Residual Opportunity is the remaining opportunity that still remains to be achieved even if all of the Exploits were 100% deployed.

Next, the total Result Improvement Space (RIS) is calculated, i.e. difference between the Maximum Opportunity Level, and the Residual Opportunity:

RIS^{xpq}=MO^{xpq}−Pot Res Opp^{xpq}

RIS¹¹¹=MO¹¹¹−Pot Res Opp¹¹¹

RIS¹¹¹=£500,000−£82,500=£417,500

It is ‘within’ this space that the applicable Exploits need effectively to be deployed to increase the actual result up to the level of the Potential Result Improvement.

Potential Result Improvement(Pot Result Impr^{xpq})=RIS^{xpq}

Next, the size of each ‘slice’ of the Result Improvement Space (RIS) is calculated, i.e. Result Improvement Space/Maximum Opportunity:

Slice RIS^{xpq}=RIS^{xpq}/MO^{xpq}

Slice RIS¹¹¹=RIS¹¹¹/MO¹¹¹

Slice RIS¹¹¹=£417,500/£500,000=0.835

A ‘slice’ is a defined unit by which the RIS may usefully and conveniently be divided. Each Exploit will then be responsible for filling the number of slices that fall within its allocated part of the Space, based on its relative % Opportunity Realisation Metric as compared with other Exploits.

Next, the total of all the ORMs from all the applicable Exploits is calculated, as follows:

Total ORM^{xpq}=ORM^{1xpq}+ORM^{2xpq} . . . +ORM^{yxpq}

Total ORM¹¹¹=ORM¹¹¹¹+ORM²¹¹¹

Total ORM¹¹¹=70%+45%=115%

This is repeated for each applicable Exploit (E^{yxpq})

The percentage contribution of the total opportunity realisation from each exploit is then calculated, based on the individual Opportunity Realisation Metrics, as a percentage of the total:

$${OR}^{yxpq} Contribution = {ORM}^{yxpq} / Total {ORM}^{xpq}$$

$$\begin{matrix}{OR}^{1111} Contribution = {ORM}^{1111} / Total {ORM}^{111} \\ = 70 \% / 115 \% \\ = 0.61\end{matrix}$$

$$\begin{matrix}{OR}^{2111} Contribution = {ORM}^{2111} / Total {ORM}^{111} \\ = 45 \% / 115 \% \\ = 0.39\end{matrix}$$

The Opportunity Realisation Metric Contribution is multiplied by the Potential Result Improvement, to give the Relative Opportunity Realisation of each Exploit:

Relative Opp Real^{yxpq}=OR^{yxpq}Contribution*Pot Result Impr^{xpq}

Relative Opp Real¹¹¹¹=OR¹¹¹¹Contribution*Pot Result Impr¹¹¹

=0.61*£417,500

=£254,674

Relative Opp Real²¹¹¹=OR²¹¹¹Contribution*Pot Result Impr¹¹¹

=0.39*£417,500

=£162,825

This is then multiplied by the Slice size, as above:

=Relative Opp Real^{yxpq}*Slice RIS^{xpq}

=(for Exploit 1)£254,674*0.835=£212,652

=(for Exploit 2)£162,825*0.835=£135,958

The Adjusted Exploit Deployment % (ADE) is taken into account to calculate the opportunity realisation (Opp Real.) from each Exploit:

Opp Real^{yxpq}=ADE^{yq}*Relative OR^{yxpq}*Slice RIS^{xpq}

Opp Real¹¹¹¹=60%*£212,652=£127,591

Opp Real²¹¹¹=80%*£135,958=£108,766

The Opportunity Realisations from all exploits that realise the Opportunity/Results Type are summed to calculate the total Forecast Result Improvement:

Forecast Result Improvement^{xpq}=Opp Real^{1xpq}+Opp Real^{2xpq} . . . +Opp Real^{mxpq}

Forecast Result Improvement¹¹¹=£127,591+£108,766=£236,357

Once the Forecast Result Improvement has been calculated, the reduction in the Initial Results Forecast is then calculated.

### Formula for Calculating Reduction in Initial Results Forecast

The following steps are repeated for each: Risk (n)/Results Type (p)/Time Period (q) relationship.

The untreated risk is calculated for the results type/time period, e.g.:

UR^{npq}=RR^{npq}*RL^{npq}

UR¹¹¹=RR¹¹¹*RL¹¹¹

=£500,000*30%=£150,000

Then the Potential Residual Risk (Pot Res Risk) Level is calculated, by repeatedly applying the % Risk Reduction Metric for each applicable Control, RRM^{mnp}:

$$Pot Res {Risk}^{npq} = {UR}^{npq} * ( 1 - {RRM}^{1 npq} ) * ( 1 - {RRM}^{2 npq} ) … * ( 1 - {RRM}^{mnpq} )$$

$$Pot Res {Risk}^{111} = {UR}^{111} * ( 1 - {RRM}^{1111} ) * ( 1 - {RRM}^{2111} )$$

$$\begin{matrix} Pot Res {Risk}^{111} = £150 , 000 * ( 1 - 60 \% ) * ( 1 - 50 \% ) \\ = £30 , 000\end{matrix}$$

The total Risk Reduction Space (RRS), i.e. difference between the Untreated Risk Level, is calculated and the Potential Residual Risk Level:

RRS^{npq}=UR^{npq}−Pot Res Risk^{npq}

RRS¹¹¹=UR¹¹¹−Pot Res Risk¹¹¹

=£150,000−£30,000=£120,000

As above, it is ‘within’ this space that the applicable controls need effectively to be deployed to reduce the Untreated Risk Level down to the Potential Residual Risk Level.

The size of each ‘slice’ of the Risk Reduction Space is calculated, i.e. Risk Reduction Space/Untreated Risk Level:

Slice RRS^{npq}=RRS^{npq}/UR^{npq}

Slice RRS¹¹¹=RRS¹¹¹/UR¹¹¹

Slice RRS¹¹¹=£120,000/£150,000=0.8

Each Control is then responsible for reducing to zero the number of slices that fall within its allocated part of the Space, based on its relative Risk Reduction % as compared with other controls.

Then, the total of all the RRMs from all the applicable controls is calculated, as follows:

Total RRM^{npq}=RRM^{1npq}+RRM^{2npq} . . . +RRM^{mnpq}

Total RRM¹¹¹=RRM¹¹¹¹+RRM²¹¹¹

Total RRM¹¹¹=60%+50%=110%

This is then repeated for each applicable Control (C^{mnpq})

The percentage contribution of the total risk reduction from each control is calculated, based on the individual Risk Reduction Metrics, as a percentage of the total:

$${RiskRed}^{mnpq} Contribution = {RRM}^{mnpq} / Total {RRM}^{npq}$$

$$\begin{matrix}{RiskRed}^{1111} Contribution = {RRM}^{1111} / Total {RRM}^{111} \\ = 60 \% / 110 \% \\ = 55 \%\end{matrix}$$

$$\begin{matrix}{RiskRed}^{1111} Contribution = {RRM}^{2111} / Total {RRM}^{111} \\ = 50 \% / 110 \% \\ = 45 \%\end{matrix}$$

Next, the Risk Reduction Contribution is multiplied by the Untreated Risk Level, to give the Relative Risk Reduction of each control:

Relative Risk Red^{mnpq}=RiskRed^{mnpq}Contribution* UR^{npq}

Relative Risk Red¹¹¹¹=RiskRed¹¹¹¹Contribution* UR¹¹¹

=55%*£150,000

=£82,500

Relative Risk Red²¹¹¹=RiskRed²¹¹¹Contribution* UR¹¹¹

=45%*£150,000

=£67,500

This is then multiplied by the Slice size, as above:

$$\begin{matrix}Relative Risk {Red}^{mnpq} * Slice {RRS}^{npq} = ( for Control 1 ) £82 , 500 * 0.8 \\ = £66 , 000 \\ = ( for Control 2 ) £67 , 500 * 0.8 \\ = £54 , 000\end{matrix}$$

The Adjusted Control Deployment % (ADC) is taken into account to calculate the risk reduction (Risk Red) from each Control:

Risk Red^{mnpq}=ADC^{mq}*Relative Risk Red^{mnpq}* Slice RRS^{npq}

Risk Red¹¹¹¹=20%*£66,000=£13,200

Risk Red²¹¹¹=60%*£54,000=£32,400

The Risk Reductions from all controls that protect against the Risk/Results Type are summed to calculate the total Risk Reduction:

Total Risk Red^{npq})=Risk Red^{1npq}+Risk Red^{2npq} . . . +Risk Red^{npq}

Total Risk Red=£13,200+£32,400=£45,600

The Forecast Result Reduction (For Res Red) for the Risk/Result Type is then calculated by subtracting the Total Risk Reduction from the Untreated Risk:

For Res Red^{npq}=UR^{npq}−Total Risk Red^{npq}

For Res Red¹¹¹=£150,000−£45,600=£104,400

Now that the Forecast Result Reduction has been calculated as well as the Forecast Result Improvement, the Net Opportunity & Risk Adjusted Results Forecast can be easily calculated.

### Formula for Calculating Net Opportunity & Risk Adjusted Results Forecast

The Forecast Result Improvement (For Res Imp) is simply added to the Initial Results Forecast (Initial Res For) and the Forecast Result Reduction (For Res Red) is subtracted:

Res For =Initial Res For +For Res Imp−For Res Red

Res For =£10,000,000+£267,357−£104,400=£10,162,957

In the calculation above, Adjusted Exploit Deployment is used. A Formula for Calculating Adjusted Exploit Deployment is as follows:

If Exploit E^{y} is:
Z¹% dependent on E¹, and
Z²% dependent on E², and
:
Z^{t}% dependent on E^{t}

The Deployment of Exploit E^{y} is denoted as DE^{y}. The Adjusted Deployment of Exploit E^{y} is denoted as ADE^{y} and calculated as follows:

ADE^{y}=DE^{y}*(1−((1−ADE¹)*Z¹%))*(1−((1−ADE²)*Z²%))* . . . *(1−((1−ADE^{t})*Z^{t}%))

Z¹%+Z²%+ . . . Z^{t}% must not exceed 100%. In addition, t<y since an Exploit cannot be dependent on itself or indeed dependent on exploits that are in turn dependent on the original exploit. A worked example is not provided since it is very similar to that given above with respect to the Adjusted Control Deployment.

In the present example, a Formula for Calculating Adjusted Control Deployment (ADC^{m}) if Control C^{m} is:
V¹% dependent on C¹, and
V²% dependent on C², and
:
V^{t}% dependent on C^{t}
And the Deployment of Control C^{m} is denoted as DC^{m}., is as follows:

ADC^{m}=DC^{m}*(1−((1−ADC¹)*V¹%))*(1−((1−ADC²)*V²%))* . . . *(1−((1−ADC^{t})*V^{t}%))

V¹%+V²%+ . . . V^{t}% must not exceed 100% and t<m since a Control cannot be dependent on itself (or indeed dependent on controls that are in turn dependent on the original control). Again, no worked example is provided since it is very similar to the corresponding example given above.

### Formula for Calculating Average Adjusted Exploit Deployment

If there are ‘y’ exploits helping to enhance Opportunity ‘x’ the average adjusted deployment of all exploits that enhance Opportunity ‘x’ is calculated by taking the mean of the individual adjusted exploit deployments:

ADE^{x}=(ADE^{1x}+ADE^{2x}+ . . . ADE^{yx})/y

### Formula for Calculating Average Adjusted Control Deployment

If there are ‘m’ controls protecting against Risk ‘n’ the average adjusted deployment of all Controls that protect against Risk ‘n’ is calculated by taking the mean of the individual adjusted control deployments:

ADCⁿ=ADC¹ⁿ+ADC²ⁿ+ . . . ADC^{mn})/m

For ease of use and to provide a user friendly and intuitive interface, the outputs of the above system and calculations are provided as dashboards, gauges/barometers and charts in a similar way to those described above with reference to the example in which only risks are taken into account.

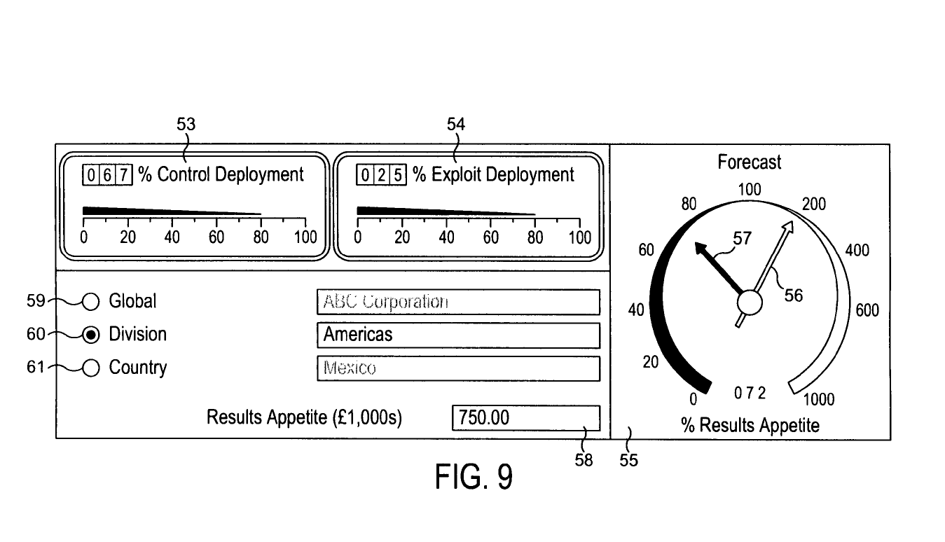

FIG. 9 shows a schematic representation of a gauge showing Forecast Results as a percentage of Results Appetite and barometers showing the average percentage deployment of exploits and controls. It will be appreciated that where the system is used only to manage opportunities, analogous to the situation described above and shown in FIGS. 1 to 7 where only risk is considered, a gauges structured to show only opportunity associated parameters can be utilised. For example a gauge might show only the Forecast Results as a percentage of Results Appetite and a Barometer showing the average percentage deployment of exploits.

Referring to FIG. 9, a main gauge 55 is provided that shows a user at a glance whether they are currently operating above or below their Results Appetite. An arrow 56 shows the potential results, i.e. the results that would be achieved if all exploits of opportunities and all controls of risks were fully deployed. The current average control and exploit deployment as a percentage can be seen on the scales 53 and 54 respectively. The Net Opportunity and Risk Adjusted Forecast Results as a percentage of Results Appetite (which represents the minimum acceptable level of results) is shown by the arrow 57 on the gauge 55. The numerical value for the Results Appetite is shown in box 58 and can be changed as desired by a user, e.g. to reflect a business situation or to see how the business is operating if the Results Appetite were different.

Thus, it is possible for a user to see at glance how the business is performing in terms of risks and opportunities and the expressed Results Appetite. A user can change the Results Appetite and immediately be presented with information which shows how the current risks and opportunities facing the company “measure up” against the Results Appetite. A user can see if the company can “safely” afford to be exposed to greater risk whilst still remaining within the desired Results Appetite.

FIGS. 10 to 12 show schematically how screens may look for a user of the system with respect to both risks and opportunities.

As shown in FIG. 10, the user can select display of different levels by checking of the corresponding selection box 59,60,61. Thus, selection of the first selection box 61 causes the display window 10a to be displayed to display the relevant data for the country level; selection of the second selection box 60 causes the display window 10b to be displayed to display the relevant data for the division level; and selection of the third selection box 59 causes the display window 10c to be displayed to display the relevant data for the global level. In this example, the results appetite shown in the window 58 is the results appetite that pertains to the level of the hierarchy selected by the user by checking of the corresponding selection box 59,60,61. Similarly, checking the selection box 59,60,61 also results in the gauge 55 and the barometers 53 and 54 displaying the data pertaining to the selected level in the hierarchy.

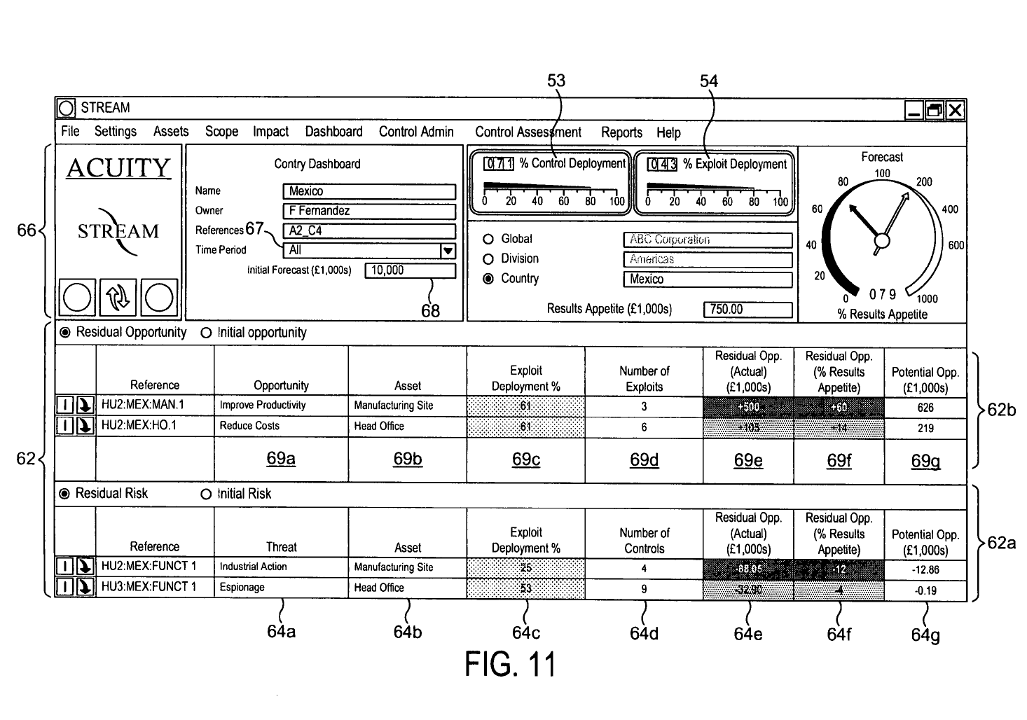

Referring now to FIG. 11, at the lowest level in the hierarchy, in the preferred embodiment information relating to all of the opportunities and risks that affect that level is displayed in information fields 62. In this example, the risks 62a are displayed in terms of threats 64a to assets 64b. The (average) amount of deployment 64c of the relevant control(s) to those risks are also displayed. There can also be displayed the number of controls 64d that are applicable to each risk, the actual risk 64e relating to each risk, the risk 64f as a percentage of results appetite, and the potential risk 64g.

Corresponding fields are provided for the Opportunities data. In this example, the opportunities 69a are displayed in terms of opportunities 69a to assets 69b. The (average) amount of deployment 69c of the relevant exploit(s) to those opportunities are also displayed. There can also be displayed the number of exploits 69d that are applicable to each opportunity, the actual opportunity 69e relating to each opportunity, the opportunity 69f as a percentage of results appetite, and the potential opportunity 69g.

Within the upper region 66 of the display there are provided fields 67,68 to enable selection of a time period 67 and to input an Initial Results Forecast 68. As in FIG. 9, since the display is to present information to enable management of both risks and opportunities barometers 53 and 54 are provided to display both Control and Exploit deployment percentages.

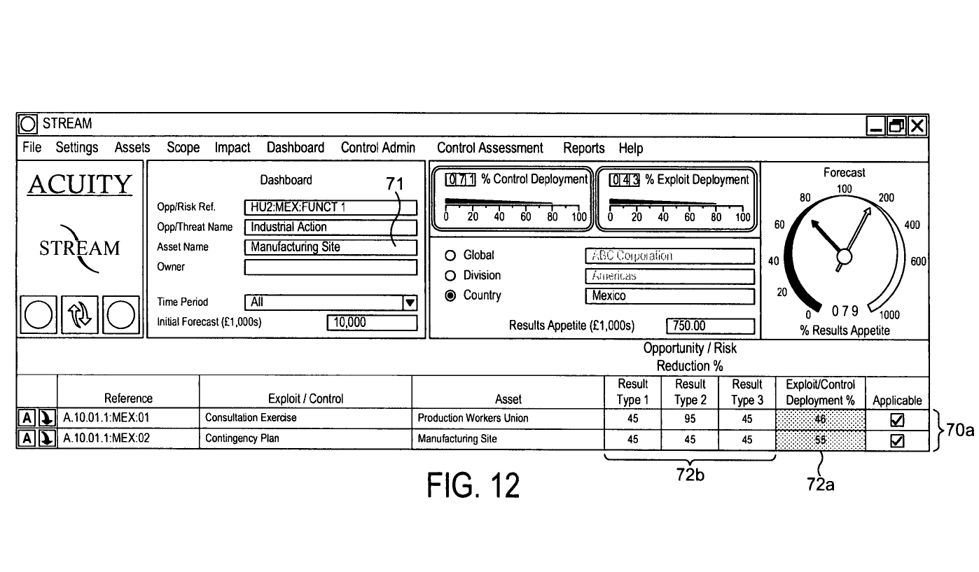

Referring now to FIG. 12, by individually selecting rows in the information fields 62a or 62b in the display of FIG. 11, the user can then be presented with information fields 70a that relate to all of the exploits or controls that are applicable to the corresponding opportunity or risk. In the example shown in FIG. 12, the Risk “Industrial Action” has been selected as can bee seen from box 71. The column 72a shows the Percentage Adjusted Deployment of each control for the risk “Industrial Action”. The columns 72b show values for Opportunity Realisation and/or Risk Reduction percentages in respect of the three (in this example) available results types for each of the controls “Consultation Exercise” and “Contingency Plan” that are available to control the risk “Industrial Action”.

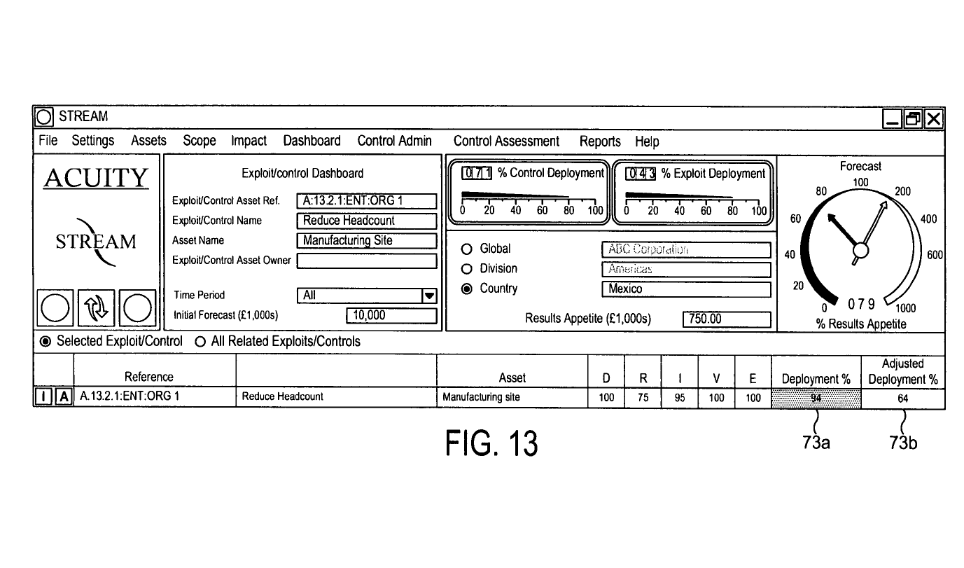

Referring now to FIG. 13, by individually selecting rows in the information fields 70a in the display of FIG. 12, the user can then be presented with more information about the corresponding exploit or control. The information that is displayed here in this preferred example includes in particular the percentage deployment 73a of each exploit or control and the percentage adjusted deployment 73b of each exploit or control, the adjusted deployment here in this example being the adjusted deployment that is obtained in the preferred method described above. Such a process of going from the initial display screen to a selected risk or opportunity and from there on to a selected exploit or control is what may be referred to as an example of “drilling down”.

As for the examples described above with respect to risk only, data can be calculated at one level, e.g. country, and then aggregated up to higher levels, e.g. regions or global.

Although the embodiments of the invention described with reference to the drawings in general comprise computer processes performed in computer apparatus and computer apparatus itself, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier be any entity or device capable of carrying the program. For example, the carrier may comprise a storage medium, such as a ROM, for example a CD ROM or a semiconductor ROM, or a magnetic recording medium, for example a floppy disk or hard disk. Further, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

Many of the processing steps may be carried out using software, dedicated hardware (such as ASICs), or a combination.

Embodiments of the present invention have been described with particular reference to the examples illustrated. However, it will be appreciated that variations and modifications may be made to the examples described within the scope of the present invention. For example, instead of single figures being used for data inputs, such as Untreated Impact (UI), Untreated Likelihood (UL) and Risk Reduction (RR) %, as described above, a set of figures could be entered for one or more of these and some form of stochastic analysis (e.g. Monte Carlo analysis) used to calculate a range of possible residual risks. This would allow results such as “there is a 5% chance of risk appetite being exceeded” to be provided.

1. A method for enabling management of at least one risk having an untreated risk level and to which one or more controls that mitigate the risk can be applied, the method comprising:
(i) determining the total risk reduction of all controls applicable to at least one risk assuming that all said controls are fully applied to mitigate said risk and that all said controls are independent of each other;
(ii) determining the contribution of the or each said control to said total risk reduction;
(iii) determining the level of actual risk reduction from each said control taking into account, for each of said controls, the contribution of the or each control to said total risk reduction, the dependency of the control on other controls applicable to said risk, and the degree to which the control is applied to mitigate said risk; and,
(iv) determining from said levels of actual risk reduction from each said control the total actual risk reduction applied to said risk.

2. A method to claim 1, wherein said risk can have plural different impacts, and (i) to (iv) are carried out for each impact for said risk.

3. A method according to claim 1, comprising:
determining the potential residual risk of said risk in terms of the level of said risk in the case that all said applicable controls that mitigate said risk are fully applied to said risk.

4. A method according to claim 3, comprising causing a display device to display a representation of said potential residual risk.

5. A method according to claim 1, comprising:
determining the total actual residual risk resulting from application of said controls to said risk; and,
causing a display device to display a representation of said total actual residual risk.

6. A method according to claim 5, wherein the representation of said total actual residual risk is a representation of said total actual residual risk as a proportion of risk appetite as input by a user.

7. A method according to claim 1, wherein there are plural risks, and comprising:
carrying out the method in respect of each of the plural risks; and,
determining the total actual residual risk of all of the plural risks by summing the total actual risk reductions applied to each of said risks.

8. Apparatus for enabling management of at least one risk having an untreated risk level and to which one or more controls that mitigate the risk can be applied, the apparatus being arranged to:
(i) determine the total risk reduction of all controls applicable to at least one risk assuming that all said controls are fully applied to mitigate said risk and that all said controls are independent of each other;
(ii) determine the contribution of the or each said control to said total risk reduction;
(iii) determine the level of actual risk reduction from each said control taking into account, for each of said controls, the contribution of the or each control to said total risk reduction, the dependency of the control on other controls applicable to said risk, and the degree to which the control is applied to mitigate said risk; and
(iv) determine from said levels of actual risk reduction from each said control the total actual risk reduction applied to said risk.

9. Apparatus according to claim 8, wherein said risk can have plural different impacts, the apparatus being arranged to carry out each of the determinations of (i) to (iv) for each impact for said risk.

10. Apparatus according to claim 8, the apparatus being arranged to:
determine the potential residual risk of said risk in terms of the level of said risk in the case that all said applicable controls that mitigate said risk are fully applied to said risk.

11. Apparatus according to claim 10, the apparatus being arranged to cause a display device to display a representation of said potential residual risk.

12. Apparatus according to claim 8, the apparatus being arranged to:
determine the total actual residual risk resulting from application of said controls to said risk; and,
cause a display device to display a representation of said total actual residual risk.

13. Apparatus according to claim 12, wherein the apparatus is arranged so that the representation of said total actual residual risk is a representation of said total actual residual risk as a proportion of risk appetite as input by a user.

14. Apparatus according to claim 8, wherein there are plural risks, the apparatus being arranged to:
carry out the method in respect of each of the plural risks; and
determine the total actual residual risk of all of the plural risks by summing the total actual risk reductions applied to each of said risks.

15. A method of displaying the effect of applying one or more controls to a risk to mitigate the risk, the method comprising:
displaying on a display device a representation of the potential residual risk of a risk, the potential residual risk of the risk being a measure of the level of said risk in the case that all applicable controls that mitigate said risk are fully applied to said risk; and,
displaying on the display device a representation of the total actual risk reduction applied to said risk by application of said one or more controls as a proportion of a risk appetite input by a user.

16. A method according to claim 15, wherein the potential residual risk of said risk and the total actual risk reduction applied to said risk as a proportion of a risk appetite input by a user are represented on the display device by respective pointers on the same gauge.

17. A method according to claim 15, comprising:
displaying on the display device a representation of the degree to which said one or more controls are applied to mitigate said risk.

18. A method according to claim 15, comprising:
displaying on the display device information relating to said risk;
detecting selection on the display device of said information relating to said risk and, in response thereto, displaying information on the display device relating to said one or more controls that can be applied to mitigate said risk.

19. A method according to claim 18, wherein the information relating to said one or more controls that can be applied to mitigate said risk that is displayed on the display device includes information relating to the degree to which said one or more controls are applied to mitigate said risk.

20. Apparatus for displaying the effect of applying one or more controls to a risk to mitigate the risk, the apparatus comprising:
a display device;
the apparatus being arranged to:
display on the display device a representation of the potential residual risk of a risk, the potential residual risk of the risk being a measure of the level of said risk in the case that all applicable controls that mitigate said risk are fully applied to said risk; and,
display on the display device a representation of the total actual risk reduction applied to said risk by application of said one or more controls as a proportion of a risk appetite input by a user.

21. Apparatus according to claim 20, the apparatus being arranged so that the potential residual risk of said risk and the total actual risk reduction applied to said risk as a proportion of a risk appetite input by a user are represented on the display device by respective pointers on the same gauge.

22. Apparatus according to claim 20, the apparatus being arranged to:
display on the display device a representation of the degree to which said one or more controls are applied to mitigate said risk.

23. Apparatus according to claim 20, the apparatus being arranged to:
display on the display device information relating to said risk;
detect selection on the display device of said information relating to said risk and, in response thereto, display information on the display device relating to said one or more controls that can be applied to mitigate said risk.

24. Apparatus according to claim 23, the apparatus being arranged so that the information relating to said one or more controls that can be applied to mitigate said risk that is displayed on the display device includes information relating to the degree to which said one or more controls are applied to mitigate said risk.

25. A method for enabling management of at least one opportunity having a maximum opportunity level and to which one or more exploits that realise the opportunity can be applied, the method comprising:
(i) determining the total opportunity improvement of all exploits applicable to at least one opportunity assuming that all said exploits are fully applied to realise the opportunity and that all said exploits are independent of each other;
(ii) determining the contribution of the or each said exploit to said total opportunity increase;
(iii) determining the level of actual opportunity increase from each said exploit taking into account, for each of said exploits, the contribution of the or each exploit to said total opportunity increase, the dependency of the exploit on other exploits applicable to said opportunity, and the degree to which the exploit is applied to realise said opportunity; and,
(iv) determining from said levels of actual opportunity increase from each said exploit the total actual result improvement applied to said result.

26. A method according to claim 25, wherein said opportunity can have plural different types of result improvement, and (i) to (iv) are carried out for each type of result improvement for said opportunity.

27. A method according to claim 25, wherein said opportunity can have different result improvements over respective different time periods, and steps (i) to (iv) are carried out for each type of result improvement for said opportunity for each time period.

28. A method according to claim 25, comprising:
determining the potential opportunity of said opportunity in terms of the level of said opportunity in the case that all said applicable exploits that realise said opportunity are fully applied to said opportunity.

29. A method according to claim 28, comprising causing a display device to display a representation of said potential opportunity.

30. A method according to claim 25, comprising:
determining the total actual opportunity resulting from application of said exploits to said opportunity; and,
causing a display device to display a representation of said total actual opportunity.

31. A method according to claim 30, wherein the representation of said total actual opportunity is a representation of said total actual opportunity as a proportion of a results appetite as input by a user.

32. A method according to claim 25, wherein there are plural opportunities, and the method comprises:
carrying out the method in respect of each of the plural opportunities; and,
determining the total actual opportunity of all of the plural opportunities by summing the total actual opportunity increases applied to each of said opportunities.

33. A method of displaying the effect on an Initial Results Forecast of applying one or more exploits to an opportunity in respect of the Initial Results Forecast to realise the opportunity and/or one or more controls to a risk to the Initial Results Forecast to reduce the risk, the method comprising:
displaying on a display device a representation of the potential results, the potential results being a measure of the results in the case that all applicable exploits that realise said opportunity are fully applied to said opportunity and/or all applicable controls that reduce said risk are fully applied to said risk.

34. A method according to claim 33, comprising displaying on the display device the net opportunity and risk adjusted forecast as a proportion of a results appetite input by a user, the net opportunity and risk adjusted forecast being determined by the actual risk reductions by application of said one or more controls and opportunity increases by application of said one or more exploits.

35. A method according to claim 34, wherein the representation of the potential results and the net opportunity and risk adjusted forecast as a proportion of a results appetite input by a user are represented on the display device by respective pointers on the same gauge.

36. A method according to claim 33, in which the method comprises displaying on the display device a representation of the degree to which said one or more exploits and/or controls are applied to realise said opportunity.

37. A method according to claim 33, comprising:
displaying on the display device information relating to said opportunity;
detecting selection on the display device of said information relating to said opportunity and, in response thereto, displaying information on the display device relating to said one or more exploits that can be applied to realise said risk.

38. A method according to claim 33, wherein the information relating to said one or more exploits that can be applied to realise said opportunity that is displayed on the display device includes information relating to the degree to which said one or more exploits are applied to realise said opportunity.

39. A method for enabling management of the effects on an Initial Results Forecast of at least one risk having an untreated risk level and to which one or more controls that mitigate the risk can be applied in combination with at least one opportunity to which one or more exploits can be applied to realise the opportunity, the method comprising:
(i) determining the total risk reduction of all controls applicable to at least one risk assuming that all said controls are fully applied to mitigate said risk and that all said controls are independent of each other;
(ii) determining the contribution of the or each said control to said total risk reduction;
(iii) determining the level of actual risk reduction from each said control taking into account, for each of said controls, the contribution of the or each control to said total risk reduction, the dependency of the control on other controls applicable to said risk, and the degree to which the control is applied to mitigate said risk;
(iv) determining the total increase in opportunity of all exploits applicable to at least one opportunity assuming that all said exploits are fully applied to increase the opportunity and that all said exploits are independent of each other;
(v) determining the contribution of the or each said exploit to said total increase in opportunity;
(vi) determining the level of actual opportunity increase from each said exploit taking into account, for each of said exploits, the contribution of the or each exploit to said total increase in opportunity, the dependency of the exploit on other exploits applicable to said opportunity, and the degree to which the exploit is applied to realise said opportunity; and,
(vii) determining from said levels of actual risk reduction from each said control and said levels of actual opportunity increase the total actual risk reduction and opportunity increase applied to said risk and opportunity to determine an effect on the Initial Results Forecast.

40. A method according to claim 39, in which at least one of the risk and the opportunity can have plural different types of result improvement and steps (i) to (iii) are carried out for each type of result improvement for said risk and/or steps (iv) to (vi) are carried out for each type of result improvement for said opportunity.

41. A method according to claim 39, comprising determining a measure of the potential results in the case that all applicable exploits that realise said opportunity are fully applied to said opportunity and all applicable controls that reduce said risk are fully applied to said risk; and,
causing a display device to display a representation of the potential results.

42. A method according to claim 41, comprising determining a net opportunity and risk adjusted forecast as a proportion of a results appetite input by a user, the net opportunity and risk adjusted forecast being determined by the actual risk reductions by application of said one or more controls and opportunity increases by application of said one or more exploits.

43. A method according to claim 42, comprising causing a display device to display the net opportunity and risk adjusted forecast as a proportion of a results appetite input by a user.

44. A method according to claim 43, wherein the representation of the potential results and the net opportunity and risk adjusted forecast as a proportion of a results appetite input by a user are represented on the display device by respective pointers on the same gauge.

45. A method according to claim 39, wherein said opportunity can have different result improvements over respective different time periods, and steps (iv) to (vii) are carried out for each type of result improvement for said opportunity for each time period.

46. Apparatus being arranged to perform the method of claim 25.

47. Apparatus for displaying the effect of applying one or more exploits to an opportunity to realise the opportunity, the apparatus comprising:
a display device;
the apparatus being arranged to:
display on the display device a representation of the potential opportunity of an opportunity, the potential opportunity of the opportunity being a measure of the level of the opportunity in the case that all applicable exploits that realise said opportunity are fully applied to said opportunity; and,
display on the display device a representation of the total actual increase in results achieved by the opportunity by application of said one or more exploits as a proportion of a results appetite input by a user.

48. A computer program containing instructions for causing a computer to carry out a method according to claim 1.

49. A computer program containing instructions for causing a computer to carry out a method according to claim 15.

50. A computer program containing instructions for causing a computer to carry out a method according to claim 25.

51. A computer program containing instructions for causing a computer to carry out a method according to claim 39.

52. A computer program containing instructions for causing a computer to carry out a method according to claim 33.

53. Apparatus being arranged to perform the method of claim 15.

54. Apparatus being arranged to perform the method of claim 33.

55. Apparatus being arranged to perform the method of claim 39.
